(19) United States
(12) Patent Application Publication
(10) Pub. No.: US 2023/0358355 A1
(43) Pub. Date: Nov. 9, 2023

(54) EFFICIENT INDIRECT ELECTRICAL HEATING

(71) Applicants: BASF SE, Ludwigshafen am Rhein (DE); Linde GmbH, Pullach (DE)

(72) Inventors: Kiara Aenne KOCHENDOERFER, Ludwigshafen am Rhein (DE); ERIC JENNE, Ludwigshafen am Rhei (DE); Andrey SHUSTOV, Ludwigshafen am Rhein (DE)

(21) Appl. No.: 18/029,386

(22) PCT Filed: Oct. 1, 2021
(86) PCT No.: PCT/EP2021/077104

§ 371 Date: Mar. 30, 2023

(30) Foreign Application Priority Data
Oct. 2, 2020 (EP) 20199923.2

(51) Int. Cl. F16L 53/37; F24H 1/10; H05B 1/02

(52) U.S. Cl. CPC F16L 53/37; F24H 1/105; H05B 1/0244

(57) ABSTRACT

Proposed is a device (110) comprising at least one pipeline (112) for receiving at least one feedstock. The device (110) has at least one current-conducting medium (129). The device (110) has at least one current or voltage source (126) which is configured to generate an electrical current in the current-conducting medium (129), which heats the pipeline (112) by means of Joule heating which is produced when the electrical current passes through the current-conducting medium (129).

The invention relates to a device comprising at least one pipeline and to a method of heating a feedstock in a pipeline.

Such devices are known in principle. For example, WO 2015/197181 A1 describes a device for heating a fluid comprising at least one electrically conductive pipeline for receiving the fluid, and at least one voltage source connected to the at least one pipeline. The at least one voltage source is set up to generate an alternating electrical current in the at least one pipeline, which heats the at least one pipeline in order to heat the fluid.

WO 2020/035575 describes a device for heating a fluid. The device comprises—at least one electrically conductive pipeline and/or at least one electrically conductive pipeline segment for receiving the fluid, and—at least one DC power source and/or DC voltage source, wherein each pipeline and/or each pipeline segment is assigned a DC power source and/or a DC voltage source which is connected to the respective pipeline and/or to the respective pipeline segment, wherein the respective DC power source and/or DC voltage source is designed to generate an electrical current in the respective pipeline and/or in the respective pipeline segment which heats the respective pipeline and/or the respective pipeline segment by Joule heating that arises on passage of electrical current through conductive pipe material, in order to heat the fluid.

CA 2 613 726 A1 discloses demand-controlled water heaters and methods of operation thereof. The water heater contains an electrolytic heating subsystem which is a pulsed electrolysis system that gets hot during operation. In the vicinity of the electrolysis vessel of the electrolytic heating subsystem is a heat exchange conduit integrated into a water conduit. When water flows through the demand-controlled hot water provider, the water flows through the heat exchange conduit and is heated thereby. CA 2 613 908 A1 discloses a radiative heating system and a method of operation thereof. The system uses an electrolytic heating subsystem. The electrolytic heating subsystem is a pulsed electrolysis system which heats the medium present in the electrolysis vessel during operation. The heated medium is circulated through a heat exchanger connected via a first conduit to the electrolysis vessel, which heats the heat exchanger. A heat carrier medium is circulated via a second conduit through the radiative heating hose and the heat exchanger. While the heat carrier medium circulates through the heat exchanger, it is heated, in which case the heat absorbed is radiated through the radiative heating tube hose. U.S. Pat. No. 3,855,449 A describes two intercommunicating chambers each containing an amount of liquid electrolyte and an amount of electrolyte in vapor form. The vapor-containing portions of the chambers are interconnected, and the liquid-containing portions of the chambers are interconnected. One of the chambers accommodates electrodes that can be connected to an electrical energy source in order to bring about heating of the electrodes and evaporation of the liquid electrolyte. In the other chamber is a heat exchanger through which a medium to be heated can flow. Disposed in the connection between the vapor-containing parts of the chambers is a valve that responds to the temperature of the medium to be heated. If heating of the medium is required, the valve is opened, such that evaporated electrolyte can flow out of the chamber in which the electrodes are present into the other chamber and can condense at the heat exchanger. The heat released by the condensed electrolyte is transferred to the medium.

However, known devices for heating a fluid in a pipeline are often technically complex or can only be implemented with a high level of technical complexity.

It is therefore an object of the present invention to provide a device comprising at least one pipeline for receiving at least one feedstock and a method of heating a feedstock, which at least largely avoid the disadvantages of known apparatuses and methods. In particular, the device and the method should be technically simple to implement and carry out and also be economically viable. In particular, the device is to be usable and the method is to be employable in a plant selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

This object is achieved by a device, a method and a plant having the features of the independent claims. Preferred configurations of the invention are specified inter alia in the associated subsidiary claims and dependency references of the subsidiary claims.

The terms “have”, “comprise” or “include” or any grammatical variations thereof are used hereinafter in a non-exclusive manner. Accordingly, these terms may relate to situations in which there are no further features apart from the feature introduced by these terms or to situations in which there is or are one or more further features. For example, the expression “A has B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when these are used in connection with one or more elements or features and are intended to express that the element or feature may be provided one or more times, are generally used only once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, in the following the terms “preferably”, “in particular”, “for example” or similar terms are used in connection with optional features, without alternative embodiments being restricted. Thus, features that are introduced by these terms are optional features, and there is no intention to restrict the scope of protection of the claims, and in particular of the independent claims, by these features. Thus, as the person skilled in the art will appreciate, the invention can also be carried out using other configurations. In a similar way, features that are introduced by “in one embodiment of the invention” or by “in one working example of the invention” are understood as optional features, without any intention that alternative configurations or the scope of protection of the independent claims be restricted thereby. Furthermore, all the possible combinations of the features thereby introduced with other features, whether optional or non-optional features, shall remain unaffected by these introductory expressions.

In a first aspect of the present invention, a device comprising at least one pipeline for receiving at least one feedstock is proposed.

A “feedstock” in the context of the present invention may be understood to mean fundamentally any material from which reaction products can be created and/or produced, especially by at least one chemical reaction. The reaction may be an endothermic reaction. The reaction may be a non-endothermic reaction, for example a preheating or heating operation. The feedstock may especially be a reactant with which a chemical reaction is to be conducted. The feedstock may be liquid or gaseous. The feedstock may be a hydrocarbon to be subjected to thermal cracking and/or a mixture. The feedstock may include at least one element selected from the group consisting of: methane, ethane, propane, butane, naphtha, ethylbenzene, gas oil, condensates, biofluids, biogases, pyrolysis oils, waste oils and liquids composed of renewable raw materials. Biofluids may, for example, be fats or oils or derivatives thereof from renewable raw materials, for example bio oil or biodiesel. Other feedstocks are also conceivable.

In the context of the present invention, a “pipeline” may be understood to be any shaped apparatus set up to receive and/or to transport the feedstock. The pipeline may be and/or include at least one reaction tube in which at least one chemical reaction can proceed. The pipeline may comprise at least one pipe and/or at least one pipeline segment and/or at least one pipeline coil. A pipeline segment may be a subregion of a pipeline. The expressions “pipeline” and “pipeline segment” and “pipeline coil” are used as synonyms hereinafter. The geometry and/or surfaces and/or material of the pipeline may be dependent on a feedstock to be transported. The geometry and/or surfaces and/or material of the pipeline may also be chosen depending on a desired reaction and/or avoidance of a particular reaction. For example, it is possible to choose ceramic tubes in order to reduce coking.

The device may comprise a plurality of pipelines. The device may have I pipelines where I is a natural number not less than two. For example, the device may have at least two, three, four, five or else more pipelines. The device may have, for example, up to one hundred pipelines. The pipelines may be configured identically or differently.

The pipelines may comprise symmetric and/or asymmetric pipes and/or combinations thereof. The geometry and/or surfaces and/or material of the pipeline may be dependent on a feedstock to be transported or else dependent on an optimization of the reaction or other factors. In a purely symmetrical configuration, the device may comprise pipelines of an identical pipe type. “Asymmetric pipes” and “combinations of symmetric and asymmetric pipes” may be understood to mean that the device may comprise any combination of pipe types, which may, for example, additionally be connected as desired in parallel or in series. A “pipe type” may be understood to mean one category or pipeline design characterized by particular features. The pipe type may be characterized at least by one feature selected from the group consisting of: a horizontal configuration of the pipeline; a vertical configuration of the pipeline; a length in the inlet (I1) and/or outlet (I2) and/or transition (I3); a diameter in the inlet (d1) and outlet (d2) and/or transition (d3); number n of passes; length per pass; diameter per pass; geometry; surface; and material. The device may comprise a combination of at least two different pipe types which are connected in parallel and/or in series. For example, the device may comprise pipelines of different lengths in the inlet (I1) and/or outlet (I2) and/or transition (I3). For example, the device may comprise pipelines with an asymmetry of the diameters in the inlet (d1) and/or outlet (d2) and/or transition (d3). For example, the device may comprise pipelines with a different number of passes. For example, the device may comprise pipelines with passes with different lengths per pass and/or different diameters per pass. In principle, any combination of any pipe type in parallel and/or in series is conceivable. The individual pipelines may be assigned one or more power sources or voltage sources. The power supply and/or voltage supply may, for example, be adjusted by use of at least one controller, in each case depending on the reaction and methodology.

The device may comprise a plurality of inlets and/or outlets and/or production streams. The pipelines of different or identical pipe types may be arranged in parallel and/or in series with a plurality of inlets and/or outlets. Pipelines may take the form of various pipe types in the form of a construction kit and may be selected and combined as desired, dependent on an end use. Use of pipelines of different pipe types can enable more accurate temperature control and/or adjustment of the reaction when the feed is fluctuating and/or a selective yield of the reaction and/or an optimized methodology. The pipelines may comprise identical or different geometries and/or surfaces and/or materials.

The pipelines may be through-connected, and hence form a pipe system for receiving the feedstock. A “pipe system” may be understood to mean an apparatus composed of at least two pipelines that are especially interconnected. The pipe system may comprise incoming and outgoing pipelines. The pipe system may comprise at least one inlet for receiving the feedstock. The pipe system may comprise at least one outlet for discharging the feedstock. “Through-connected” may be understood to mean that the pipelines are interconnected in a fluid-conducting manner. Thus, the pipelines may be arranged and connected in such a way that the feedstock flows through the pipelines one after another. Two or more or all of the pipelines may be configured in series and/or in parallel. The pipelines may be interconnected parallel to one another in such a way that the feedstock can flow through at least two pipelines in parallel. The pipelines, in particular the pipelines connected in parallel, may be designed in such a way as to transport different feedstocks in parallel. In particular, the pipelines connected in parallel may have mutually different geometries and/or surfaces and/or materials for transport of different feedstocks. For the transport of a feedstock in particular, a number or all of the pipelines may be in parallel configuration, such that the feedstock can be divided among those pipelines in parallel configuration. There are also conceivable combinations of a series connection and a parallel connection.

For example, the pipeline may comprise at least one electrically conductive pipeline for receiving the feedstock. An “electrically conductive pipeline” may be understood to mean that the pipeline, in particular the material of the pipeline, is designed to conduct electrical current. However, configurations as electrically nonconductive pipelines or poorly conductive pipelines are also conceivable. The pipeline may be of electrically conductive or electrically insulating configuration. Both metallic pipelines and ceramic pipelines are conceivable.

The pipelines and correspondingly incoming and outgoing pipelines may be fluidically connected to one another. In the case of use of electrically conductive pipelines, the incoming and outgoing pipelines may be galvanically isolated from one another. “Galvanically isolated from one another” may be understood to mean that the pipelines and the incoming and outgoing pipelines are isolated from one another in such a way that there is no electrical conduction and/or a tolerable electrical conduction between the pipelines and the incoming and outgoing pipelines. The device may comprise at least one insulator, in particular a plurality of insulators. Galvanic isolation between the respective pipelines and the incoming and outgoing pipelines can be ensured by the insulators. The insulators can ensure free flow of the feedstock.

The device includes at least one current-conducting medium. The device has at least one power source or voltage source set up to create an electrical current in the current-conducting medium which heats the pipeline by Joule heating that arises on passage of the electrical current through the current-conducting medium.

A “current-conducting medium” in the context of the present invention may be understood to mean any medium having current-conducting and/or magnetic properties. Magnetic materials, i.e. current-conducting media having magnetic properties, can heat up more quickly than non-magnetic materials on account of the effects of hysteresis heating. Magnetic materials may have natural resistance to the rapidly changing magnetic fields. Materials having poor magnetic conductivity, for example aluminum or copper, can be heated less efficiently owing to their low magnetic permeability. For example, the current-conducting medium may be and/or comprise at least one material having ferromagnetic properties; for example, the magnetic permeability may be about 1 to 1000000 H/m. For example, the current-conducting medium may comprise cobalt, iron, nickel and/or ferrites. The current-conducting medium may have a specific resistivity. The current-conducting medium may be a high-resistance medium. The current-conducting medium may have a specific resistivity ρ of 0.1 Ωmm²/m≤ρ≤1000 Ωmm²/m, preferably of 10 Ωmm²/m≤ρ≤1000 Ωmm²/m. Use of such a current-conducting medium can enable minimization of the amount of power required to heat the feedstock. In principle, the power in simplified terms is P=U·I=I²·R, with voltage U, current I and resistance R. Taking account of additional inductive effects, the power may be expressed by P=((I²*R)²+(I²*2 π*f*L)²)^{0.5} where L is inductivity and f is frequency. A broader spectrum of voltage and current flows may be provided by an appropriate selection of the specific ohmic resistance of the current-conducting medium. Preference may be given to current-conducting media that can be utilized at higher temperatures. By contrast, very high pressures are needed in the case of water to obtain these temperatures; for example, 300° C. corresponds to 90 bar.

The current-conducting medium may be in any state of matter. The current-conducting medium may be in a solid, liquid and/or gaseous state of matter and include mixtures, for example emulsions and suspensions. The current-conducting medium may be a current-conducting granular material or a current-conducting fluid. The current-conducting medium may include at least one material selected from the group consisting of: carbon, carbides, silicides, electrically conductive oils, salt melts, inorganic salts and solid/liquid mixtures.

The power source and/or voltage source may comprise a single-phase or multiphase AC power source and/or single-phase or multiphase AC voltage source or a DC power source and/or DC voltage source. The device may have at least one input and output that electrically connects the power source and/or voltage source to the current-conducting medium.

The device may have, for example, at least one AC power source and/or at least one AC voltage source. The AC power source and/or an AC voltage source may be a single-phase or multiphase source. An “AC power source” may be understood to mean a power source designed to provide an alternating current. An “alternating current” may be understood to mean an electrical current of a polarity which changes in a regular repetition over time. For example, the alternating current may be a sinusoidal alternating current. A “single-phase” AC power source may be understood to mean an AC power source which provides an electrical current with a single phase. A “multiphase” AC power source may be understood as meaning an AC power source which provides an electrical current with more than one phase. An “AC voltage source” may be understood to mean a voltage source set up to provide an AC voltage. An “AC voltage” may be understood to mean a voltage of a level and polarity which are repeated regularly over time. For example, the AC voltage may be a sinusoidal AC voltage. The voltage generated by the AC voltage source causes a current to flow, in particular an alternating current to flow. A “single-phase” AC voltage source may be understood to mean an AC voltage source which provides the alternating current with a single phase. A “multiphase” AC voltage source may be understood to mean an AC voltage source which provides the alternating current with more than one phase.

The device may have at least one DC power source and/or at least one DC voltage source. A “DC power source” may be understood to mean an apparatus set up to provide a DC current. A “DC voltage source” may be understood to mean an apparatus set up to provide a DC voltage. The DC power source and/or DC voltage source may be set up to generate a DC current in the current-conducting medium. “DC current” may be understood to mean an electrical current that is substantially constant in terms of strength and direction. “DC voltage” may be understood to mean a substantially constant electrical voltage. “Substantially constant” may be understood to mean a current or a voltage having variations that are immaterial in respect of the intended effect.

The device may have a plurality of power sources and/or voltage sources, said power sources and/or voltage sources being selected from the group consisting of: single-phase or multiphase AC power sources and/or single-phase or multiphase AC voltage sources or DC power sources and/or DC voltage sources, and a combination thereof. The device may have 2 to M different power sources and/or voltage sources, where M is a natural number not less than three. The power sources and/or voltage sources may be configured with or without the possibility of controlling at least one electrical output variable. The power sources and/or voltage sources may be electrically controllable independently of one another. The power sources and/or voltage sources may be of identical or different configuration. For example, the device may be set up such that current and/or voltage are adjustable for different zones of the device. The device may have a plurality of pipelines, where the pipelines belong to different temperature regions or zones. The pipeline itself may likewise have temperature zones. Using a plurality of power sources and/or voltage sources allows the voltage in particular to be varied for different zones. For instance, it is possible to achieve not too high a current, which would result in excessively hot pipelines, or, conversely, excessively cold pipelines.

The device may have a plurality of single-phase or multiphase AC power sources or AC voltage sources. The pipelines may each be assigned a current-conducting medium with an AC power source and/or AC voltage source connected to the current-conducting medium, especially electrically via at least one electrical connection. Also conceivable are embodiments in which at least two pipelines share a current-conducting medium and an AC power source and/or AC voltage source. For connection of the AC power source or AC voltage source and the current-conducting media, the electrically heatable reactor may have 2 to N inputs and outputs where N is a natural number not less than three. The respective AC power source and/or AC voltage source may be set up to generate an electrical current in the respective current-conducting medium. The AC power sources and/or AC voltage sources may either be controlled or uncontrolled. The AC power sources and/or AC voltage sources may be configured with or without the possibility of controlling at least one electrical output variable. An “output variable” may be understood to mean a current value and/or a voltage value and/or a current signal and/or a voltage signal. The device may have 2 to M different AC power sources and/or AC voltage sources where M is a natural number not less than three. The AC power sources and/or AC voltage sources may be independently electrically controllable. For example, a different current may be generated in the respective current-conducting medium, and different temperatures reached in the pipelines.

The device may comprise a plurality of DC power sources and/or DC voltage sources. Each pipeline may be assigned a current-conducting medium and a DC power source and/or DC voltage source which is connected to the current-conducting medium, especially electrically via at least one electrical connection. For connection of the DC power sources and/or DC voltage sources and the current-conducting medium, the device may have 2 to N positive terminals and/or conductors and 2 to N negative terminals and/or conductors, where N is a natural number not less than three. The respective DC power sources and/or DC voltage sources may be set up to generate an electrical current in the respective current-conducting medium. The current generated can heat the respective pipeline by Joule heating that arises on passage of the electrical current through the current-conducting medium, in order to heat the feedstock.

The current generated in the current-conducting medium can heat the respective pipeline by Joule heating that arises on passage of the electrical current through the current-conducting medium, in order to heat the feedstock. “Warming of the pipeline” may be understood to mean an operation that leads to a change in a temperature of the pipeline, especially a rise in the temperature of the pipeline. The temperature of the pipeline may remain constant, for example when the reaction that takes place in the pipeline absorbs as much heat as it receives.

The device may be set up to heat the feedstock to a temperature in the range from 200° C. to 1700° C., preferably from 300° C. to 1400° C., more preferably from 400° C. to 875° C. The pipeline may be set up to at least partly absorb the Joule heating generated by the current-conducting medium and to at least partly release it to the feedstock. At least one endothermic reaction may take place in the pipeline. An “endothermic reaction” may be understood to mean a reaction in which energy, especially in the form of heat, is absorbed from the environment. The endothermic reaction may comprise heating and/or preheating of the feedstock.

“Heating” the feedstock may be understood to mean an operation that leads to a change in temperature of the feedstock, especially to a rise in the temperature of the feedstock, for example to heating of the feedstock. The feedstock may, for example, be warmed to a defined or predetermined temperature value by the heating.

The device may be part of a plant. For example, the plant may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

The device may, for example, be part of a steamcracker. “Steamcracking” may be understood to mean a process in which longer-chain hydrocarbons, for example naphtha, propane, butane and ethane, and also gas oil and hydrowax, are converted to short-chain hydrocarbons by thermal cracking in the presence of steam. Steamcracking can produce hydrogen, methane, ethene and propene as the main product, and also butenes and pyrolysis benzene inter alia. The steamcracker may be set up to heat the fluid to a temperature in the range from 550° C. to 1100° C.

For example, the device may be part of a reformer furnace. “Steam reforming” may be understood to mean a process for producing hydrogen and carbon oxides from water and carbon-containing energy carriers, in particular hydrocarbons such as natural gas, light gasoline, methanol, biogas or biomass. For example, the fluid may be heated to a temperature in the range from 200° C. to 875° C., preferably from 400° C. to 700° C.

For example, the device may be part of an apparatus for alkane dehydrogenation. “Alkane dehydrogenation” may be understood to mean a process for producing alkenes by dehydrogenating alkanes, for example dehydrogenating butane into butenes (BDH) or dehydrogenating propane into propene (PDH). The apparatus for alkane dehydrogenation may be set up to heat the fluid to a temperature in the range from 400° C. to 700° C.

However, other temperatures and temperature ranges are also conceivable.

The current-conducting medium may be disposed in any vessel, for example a pipe or a cylinder. The current-conducting medium may be electrically heated directly or indirectly by heating of the vessel.

The current-conducting medium and the pipeline may be arranged relative to one another such that the current-conducting medium at least partly surrounds the pipeline and/or that the pipeline at least partly surrounds the current-conducting medium. “At least partly surround” may be understood to mean embodiments in which the current-conducting medium fully surrounds the pipeline or the pipeline fully surrounds the current-conducting medium, and embodiments in which only subregions of the pipeline are surrounded by the current-conducting medium or subregions of the pipeline surround the current-conducting medium. For example, the pipeline may be disposed as an inner cylinder in a hollow cylinder and be surrounded by an outside granular material. For example, the current-conducting medium may be disposed, for example as granular material, in a pipe within the pipeline. For example, there may be a multitude of tubes filled with the current-conducting medium disposed within the pipeline. For example, multiple pipelines comprising the feedstock may be provided, which are surrounded by a cylinder comprising current-conducting medium. For example, multiple cylinders comprising current-conducting medium may be arranged in the form of a ring around the pipeline comprising the feedstock. For example, the pipeline may be spiral-shaped and a cylinder comprising the current-conducting medium, for example a granular material, may be arranged around the pipeline. For example, a spiral-shaped tube comprising current-conducting medium may be provided, which is surrounded by the pipeline comprising the feedstock. For example, multiple spiral-shaped elements may be provided in the pipeline or in the current-conducting medium. Also conceivable are embodiments in which the current-conducting medium is disposed in a plurality of hollow cylinders around various regions of a pipeline and enables individual heating of the regions of the pipeline.

Indirect heating of the pipeline can enable a simplified concept of power supply. It is possible to avoid problems that occur in the case of direct heating, such as very hot pins and strands, and high current flow. By optimizing the ohmic resistance of the current-conducting medium, it is possible to minimize the current, such that only a relatively small power demand is required by comparison with a directly heated pipeline, and transformers with lower output are correspondingly possible. In addition, it is more easily possible to achieve safety since the pipeline is not itself under voltage. The inductive resistances (reactances) that can arise in the case of direct heating and can lead to unwanted effects, for example uncontrolled unsymmetric distribution of the electrical currents in the heated pipeline, can be minimized or avoided by the use of indirect heating. Upscaling may be possible in a much simpler manner since the pipeline is decoupled from the power supply. It is also possible to use any type of current, for example DC current, 3-phase AC current etc., for this concept, and even to utilize them in combination for one process. Many combinations of pipe types are possible, and so flexible reactor design is possible. An independent feedstock concept is possible, such as single feed, co-cracking, or split cracking.

The device may have at least one coil for the purpose of inductive heating.

The power source or voltage source may be connected to that coil, which is set up to supply the coil with a voltage or a current. The current-conducting medium and the coil may be arranged such that the electromagnetic field of the coil induces an electrical current in the current-conducting medium, which heats the current-conducting medium by Joule heating that arises on passage of the electrical current through the current-conducting medium, in order to heat the feedstock.

The device may have at least one further voltage source or power source which is connected to the coil and is set up to supply the coil with a voltage or a current. The coil may be set up to generate at least one electromagnetic field as a result of the supply. For example, the pipeline may be of both electrically and magnetically conductive configuration, and the coil may be arranged such that the electromagnetic field of the coil induces an electrical current in the pipeline, which heats the pipeline by Joule heating that arises on passage of the electrical current through conductive pipe material, in order to heat the feedstock.

The coil geometry may be of any configuration. For example, the coil may be of vertical horizontal, cylindrical or else different configuration.

Multiple inductive heaters may be provided in the reaction space, which may, for example, be in parallel, series or different arrangement.

With regard to the configuration of the device, especially of the pipeline, of the current-conducting medium and of the feedstock, reference is made to the description of the device further up.

In a further aspect, in the context of the present invention, a plant comprising a device of the invention is proposed. With regard to the configuration of the plant, reference is made to the description of the devices further up or down.

The plant may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

In a further aspect, in the context of the present invention, a method of heating a feedstock is proposed. In the method, a device of the invention is used.

The method comprises the following steps:
providing at least one pipeline for receiving the feedstock and receiving the feedstock in the pipeline;
providing at least one power source and/or at least one voltage source;
generating an electrical current in a current-conducting medium in the device, which heats the pipeline by Joule heating that arises on passage of the electrical current through the current-conducting medium, in order to heat the feedstock.

With regard to embodiments and definitions, reference may be made to the above description of the device. The method steps may be carried out in the sequence specified, although it is also possible for one or more of the steps to be conducted simultaneously at least in part, and it is also possible for one or more of the steps to be repeated more than once. In addition, further steps may be additionally performed, irrespective of whether or not they have been mentioned in the present description.

In summary, in the context of the present invention, particular preference is given to the following embodiments:

Embodiment 1 A device comprising at least one pipeline for receiving at least one feedstock, said device having at least one current-conducting medium, and said device having at least one power source or voltage source set up to generate an electrical current in the current-conducting medium which heats the pipeline by Joule heating that arises on passage of the electrical current through the current-conducting medium.

Embodiment 2 The device according to the preceding embodiment, wherein the device is set up to heat the feedstock to a temperature in the range from 200° C. to 1700° C., preferably 300° C. to 1400° C., more preferably 400° C. to 875° C.

Embodiment 3 The device according to the preceding embodiment, wherein the current-conducting medium and the pipeline are arranged relative to one another such that the current-conducting medium at least partly surrounds the pipeline and/or that the pipeline at least partly surrounds the current-conducting medium.

Embodiment 4 The device according to any of the preceding embodiments, wherein the current-conducting medium is in a solid, liquid and/or gaseous state of matter and mixtures selected from the group consisting of solid, liquid and gaseous.

Embodiment 5 The device according to any of the preceding embodiments, wherein the current-conducting medium is a current-conducting granular material or a current-conducting fluid.

Embodiment 6 The device according to any of the preceding embodiments, wherein the current-conducting medium includes at least one material selected from the group consisting of: carbon, carbides, silicides, electrically conductive oils, salt melts, inorganic salts and solid/liquid mixtures.

Embodiment 7 The device according to any of the preceding embodiments, wherein at least one endothermic reaction proceeds in the pipeline, said endothermic reaction comprising heating and/or preheating of the feedstock.

Embodiment 8 The device according to any of the preceding embodiments, wherein the current-conducting medium has a specific resistivity ρ of 0.1 Ωmm²/m≤ρ≤1000 Ωmm²/m, preferably of 10 Ωmm²/m≤ρ≤1000 Ωmm²/m.

Embodiment 9 The device according to any of the preceding embodiments, wherein the power source and/or voltage source comprises a single-phase or multiphase AC power source and/or a single-phase or multiphase AC voltage source, or a DC power source and/or DC voltage source.

Embodiment 10 The device according to any of the preceding embodiments, wherein the device has a plurality of power sources and/or voltage sources, said power sources and/or voltage sources being selected from the group consisting of: single-phase or multiphase AC power sources and/or single-phase or multiphase AC voltage sources or DC power sources and/or DC voltage sources, and a combination thereof.

Embodiment 11 The device according to the preceding embodiment, wherein the power sources and/or voltage sources are configured with or without the possibility of controlling at least one electrical output variable.

Embodiment 12 The device according to the preceding embodiment, wherein the power sources and/or voltage sources are independently electrically controllable.

Embodiment 13 The device according to any of the three preceding embodiments, wherein the power sources and/or voltage sources are configured identically or differently.

Embodiment 14 The device according to any of the four preceding embodiments, wherein the current and/or voltage are adjustable for various zones of the device.

Embodiment 15 The device according to any of the preceding embodiments, wherein the device has 2 to M different power sources and/or voltage sources where M is a natural number not less than three.

Embodiment 16 The device according to any of the preceding embodiments, wherein the device has at least one input and output that electrically connects the power source and/or voltage source to the current-conducting medium.

Embodiment 17 The device according to any of the preceding embodiments, wherein the pipeline is of electrically conductive or electrically insulating configuration.

Embodiment 18 The device according to any of the preceding embodiments, wherein the device has a plurality of pipelines, said pipelines being through-connected and hence forming a pipe system for receiving the feedstock.

Embodiment 19 The device according to any of the preceding embodiments, wherein the device has I pipelines where I is a natural number not less than two, said pipelines comprising symmetric or unsymmetric tubes and/or a combination thereof.

Embodiment 20 The device according to either of the two preceding embodiments, wherein the pipelines are of different configuration in terms of diameter, and/or length, and/or geometry.

Embodiment 21 The device according to any of the preceding embodiments, wherein the pipelines and corresponding incoming and outgoing pipelines are interconnected in a fluid-conducting manner, said pipelines being metallic pipelines, said pipelines and the incoming and outgoing pipelines being galvanically insulated from one another, said device having insulators set up to ensure galvanic isolation between the respective pipelines and the incoming and outgoing pipelines, and said insulators being set up to ensure free flow of the feedstock.

Embodiment 22 The device according to any of the preceding embodiments, wherein multiple or all of the pipelines are in series and/or parallel configuration.

Embodiment 23 The device according to any of the preceding embodiments, wherein the feedstock is a hydrocarbon to be subjected to thermal cleavage and/or a mixture.

Embodiment 24 The device according to any of the preceding embodiments, said device having at least one coil for the purpose of inductive heating, said power source or voltage source being connected to the coil and being set up to supply the coil with a voltage or a current, and said current-conducting medium and said coil being arranged such that the electromagnetic field of said coil induces an electrical current in the current-conducting medium that heats the current-conducting medium by Joule heating that arises on passage of the electrical current through the current-conducting medium, in order to heat the feedstock.

Embodiment 25 The device according to any of the preceding embodiments, said device having at least one coil for the purpose of inductive heating, said device having at least one further voltage source or power source which is connected to the coil and is set up to supply the coil with a voltage or a current, said coil being set up to generate at least one electromagnetic field by virtue of the supply, and said pipeline and said coil being arranged such that the electromagnetic field of said coil induces an electrical current in the pipeline that heats the pipeline by Joule heating that arises on passage of the electrical current through conductive pipe material, in order to heat the feedstock.

Embodiment 26 A plant comprising at least one device according to any of the preceding embodiments.

Embodiment 27 The plant according to the preceding embodiment, wherein the plant is selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

Embodiment 28 A method for heating at least one feedstock using a device according to any of the preceding embodiments relating to a device, said method comprising the following steps:
providing at least one pipeline for receiving the feedstock and receiving the feedstock in the pipeline;
providing at least one power source and/or at least one voltage source;
generating an electrical current in a current-conducting medium in the device, which heats the pipeline by Joule heating that arises on passage of the electrical current through the current-conducting medium, in order to heat the feedstock.

### BRIEF DESCRIPTION OF THE FIGURES

Further details and features of the invention will be apparent from the description of preferred working examples that follows, in particular in conjunction with the subsidiary claims. The respective features may be implemented on their own, or two or more may be implemented in combination with one another. The invention is not restricted to the working examples. The working examples are represented schematically in the figures. Identical reference numerals in the individual figures relate to elements that are the same or have the same function, or correspond to one another in terms of their functions.

The Specific Figures Show:

FIGS. 1a to 1c schematic diagrams of working examples of a device of the invention;

FIG. 2 a schematic diagram of a further working example of the device of the invention;

FIGS. 3a1, 3a2, 3b1 and 3b2 schematic diagrams of further working examples of the device of the invention;

FIG. 4 a schematic diagram of a working example of the device of the invention;

FIGS. 5a to 5d schematic diagrams of further working examples of the device of the invention;

FIGS. 6Ai and 6Cvi schematic diagrams of further working examples of the device of the invention;

FIGS. 7a to 7y a construction kit with pipe types and inventive working examples of combinations of pipelines and/or pipeline segments;

FIGS. 8a to 8g schematic diagrams of further working examples of the device of the invention;

FIGS. 9a to 9g schematic diagrams of further working examples of the device of the invention; and

FIG. 10 a schematic diagram of a further working example of the device of the invention.

### WORKING EXAMPLES

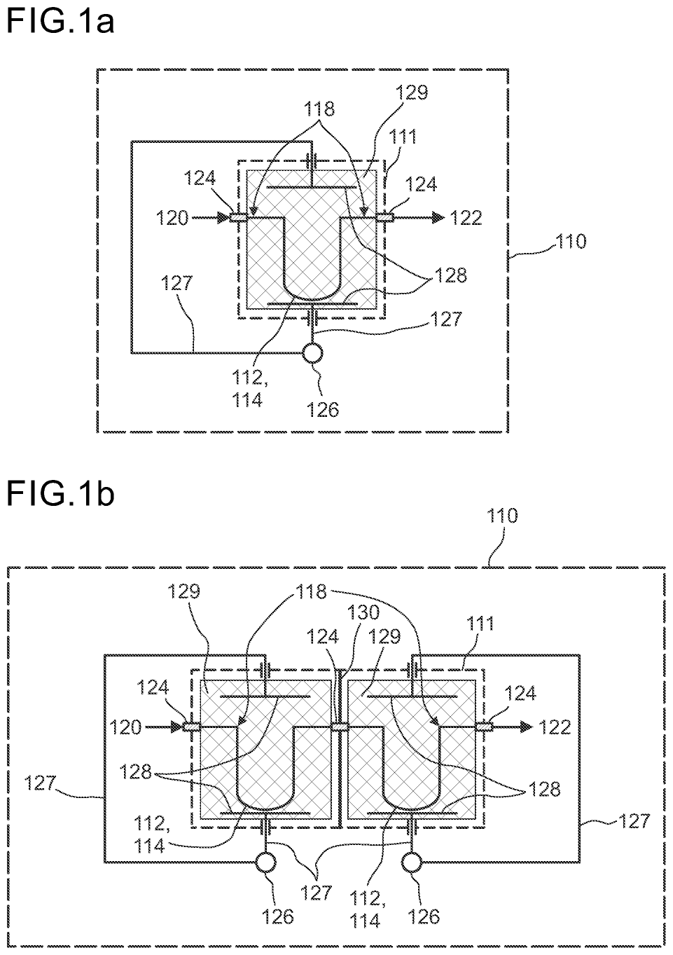

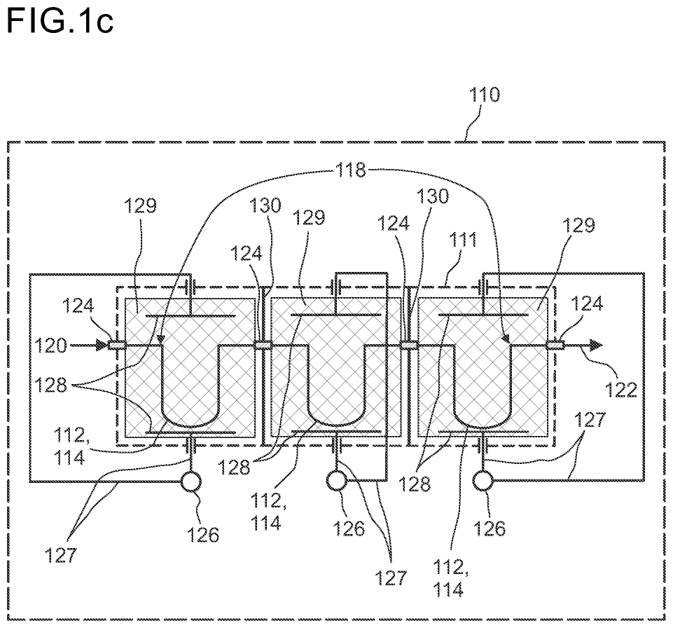

FIGS. 1a to 1c each show a schematic diagram of a working example of an inventive device 110 comprising at least one pipeline 112 for receiving at least one feedstock.

The device 110 may have at least one reactive space 111.

The feedstock may be any material from which reaction products can be produced and/or prepared, especially by at least one chemical reaction. The feedstock may especially be a reactant with which a chemical reaction is to be conducted. The feedstock may be liquid or gaseous. The feedstock may be a hydrocarbon to be subjected to thermal cracking and/or a mixture. The feedstock may include at least one element selected from the group consisting of: methane, ethane, propane, butane, naphtha, ethylbenzene, gas oil, condensates, biofluids, biogases, pyrolysis oils, waste oils and liquids composed of renewable raw materials. Biofluids may, for example, be fats or oils or derivatives thereof from renewable raw materials, for example bio oil or biodiesel. Other feedstocks are also conceivable.

The pipeline 112 may be set up to receive and/or to transport the feedstock. The pipeline may be and/or include at least one reaction tube in which at least one chemical reaction can proceed. The pipeline 112 may comprise at least one pipe and/or at least one pipeline segment 114 and/or at least one pipeline coil. A pipeline segment 114 may be a subregion of a pipeline 112. The geometry and/or surfaces and/or material of the pipeline 112 may be dependent on a feedstock to be transported.

FIG. 1a shows a working example in which the device has one pipeline 112. The device 110 may have a plurality of pipelines 112 and/or pipeline segments 114, for example two, as shown in FIG. 1b, or three, as shown in FIG. 1c. The device 110 may have I pipelines 112 where I is a natural number not less than two. For example, the device 110 may have at least two, three, four, five or more pipelines 112. The device 110 may have, for example, up to one hundred pipelines 112. The pipelines 112 may be of identical or different configuration.

The pipelines 112 may be through-connected, and hence form a pipe system 118 for receiving the feedstock. The pipe system 118 may be an apparatus composed of at least two pipelines 112 that are especially interconnected. The pipe system 118 may comprise incoming and outgoing pipelines. The pipe system 118 may comprise at least one inlet 120 for receiving the feedstock. The pipe system 118 may comprise at least one outlet 122 for discharging the feedstock. The pipelines 112 may be through-connected in such a way that the pipelines 112 are interconnected in a fluid-conducting manner. Thus, the pipelines 112 may be arranged and connected in such a way that the feedstock flows through the pipelines 112 one after another. Two or more or all of the pipelines 112 may be configured in series and/or in parallel. In FIGS. 1a to 1c, the feedstock flows through the pipelines 112 serially, i.e. successively.

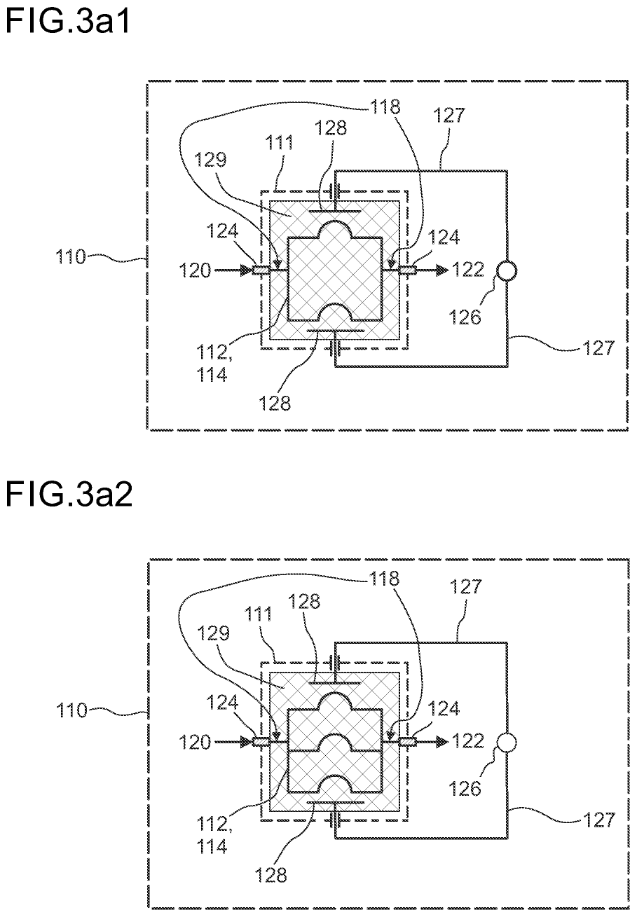

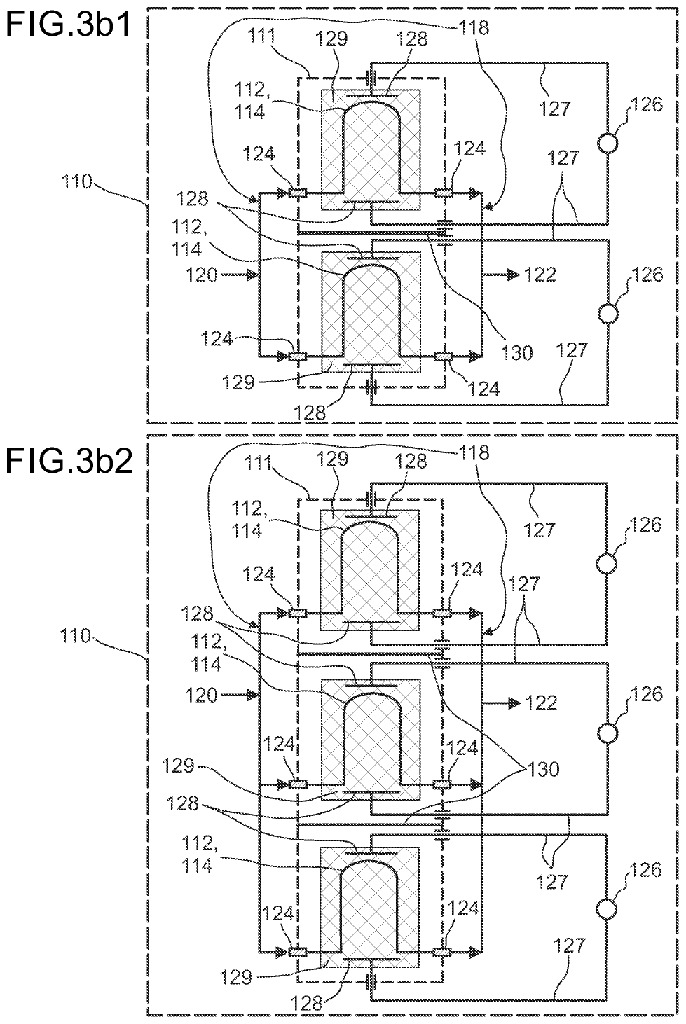

However, parallel interconnection may also be possible, in such a way that the feedstock can flow through at least two pipelines 112 in parallel. Such embodiments are shown, for example, in FIGS. 3a1 to 3b2. The pipelines 112, in particular the pipelines connected in parallel, may be designed in such a way as to transport different feedstocks in parallel. In particular, the pipelines 112 connected in parallel may have mutually different geometries and/or surfaces and/or materials for transport of different feedstocks. For the transport of a feedstock in particular, a number or all of the pipelines 112 may be in parallel configuration, such that the feedstock can be divided among those pipelines 112 in parallel configuration.

There are also conceivable combinations of a series connection and a parallel connection.

For example, the pipeline 112 may comprise at least one electrically conductive pipeline 112 for receiving the feedstock. The electrically conductive pipeline 112 may be set up to conduct electrical current. However, there are also conceivable configurations as electrically nonconductive pipelines 112 or poorly conductive pipelines 112. The pipeline 112 may be of electrically conductive or electrically insulating configuration. Both metallic pipelines 112 and ceramic pipelines 112 are conceivable.

In the case of use of electrically conductive pipelines 112, the incoming and outgoing pipelines may be galvanically isolated from one another. The pipelines 112 and the incoming and outgoing pipelines may be isolated from one another in such a way that there is no electrical conduction and/or tolerable electrical conduction between the pipelines 112 and the incoming and outgoing pipelines. The device 110 may comprise at least one insulator 124, in particular a plurality of insulators 124. Galvanic isolation between the respective pipelines 112 and the incoming and outgoing pipelines can be ensured by the insulators 124. The insulators 124 can ensure free flow of the feedstock.

The device 110 includes at least one current-conducting medium 129. The device 110 has at least one power source or voltage source 126 set up to create an electrical current in the current-conducting medium 129 which heats the pipeline 112 by Joule heating that arises on passage of the electrical current through the current-conducting medium 129.

The current-conducting medium 129 may be any medium having current-conducting and/or magnetic properties. Magnetic materials, i.e. current-conducting media 129 having magnetic properties, can heat up more quickly than non-magnetic materials on account of the effects of hysteresis heating. Magnetic materials may have natural resistance to the rapidly changing magnetic fields. Materials having poor magnetic conductivity, for example aluminum or copper, can be heated less efficiently owing to their low magnetic permeability. For example, the current-conducting medium may be and/or comprise at least one material having ferromagnetic properties, for example, the magnetic permeability may be about 1 to 1000000 H/m. For example, the current-conducting medium 129 may comprise cobalt, iron, nickel and/or ferrites. The current-conducting medium 129 may have a specific resistivity. The current-conducting medium 129 may be a high-resistance medium. The current-conducting medium 129 may have a specific resistivity ρ of 0.1 Ωmm²/m≤ρ 1000 Ωmm²/m, preferably of 10 Ωmm²/m≤ρ≤1000 Ωmm²/m. Use of such a current-conducting medium 129 can enable minimization of the amount of power required to heat the feedstock.

The current-conducting medium 129 may be in any state of matter. The current-conducting medium 129 may be in a solid, liquid and/or gaseous state of matter and include mixtures, for example emulsions and suspensions. The current-conducting medium 129 may be a current-conducting granular material or a current-conducting fluid. The current-conducting medium 129 may include at least one material selected from the group consisting of: carbon, carbides, silicides, electrically conductive oils, salt melts, inorganic salts and solid/liquid mixtures.

The power source and/or voltage source 126 may comprise a single-phase or multiphase AC power source and/or single-phase or multiphase AC voltage source or a DC power source and/or DC voltage source. The device 110 may have at least one input and output 127 that electrically connects the power source and/or voltage source 126 to the current-conducting medium 129.

The device 110 may have, for example, at least one AC power source and/or at least one AC voltage source. The AC power source and/or an AC voltage source may be a single-phase or multiphase source. The AC power source may be and/or comprise a power source set up to provide an alternating current. Alternating current may be an electrical current of a polarity which changes in a regular repetition over time. For example, the alternating current may be a sinusoidal alternating current. The single-phase AC power source may be and/or comprise an AC power source which provides an electrical current with a single phase. The multiphase AC power source may be and/or comprise an AC power source which provides an electrical current with more than one phase. The AC voltage source may be and/or comprise a voltage source set up to provide an AC voltage. The AC voltage may be a voltage of a level and polarity which are repeated regularly over time. For example, the AC voltage may be a sinusoidal AC voltage. The voltage generated by the AC voltage source causes a current to flow, in particular an alternating current to flow. The single-phase AC voltage source may be and/or comprise an AC voltage source which provides the AC current with a single phase. The multiphase AC voltage source may be and/or comprise an AC voltage source which provides the AC current with more than one phase.

The device 110 may have at least one DC power source and/or at least one DC voltage source. The DC power source may be and/or comprise an apparatus set up to provide a DC current. The DC voltage source may be and/or comprise an apparatus set up to provide a DC voltage. The DC power source and/or DC voltage source may be set up to generate a DC current in the current-conducting medium. DC current may be an electrical current that is substantially constant in terms of strength and direction. DC voltage may be a substantially constant electrical voltage.

The device 110 may have a plurality of power sources and/or voltage sources 126; see, for example, FIGS. 1b and 1c. The power sources and/or voltage sources are selected from the group consisting of: single-phase or multiphase AC power sources and/or single-phase or multiphase AC voltage sources or DC power sources and/or DC voltage sources, and a combination thereof. The device 110 may have 2 to M different power sources and/or voltage sources, where M is a natural number not less than three.

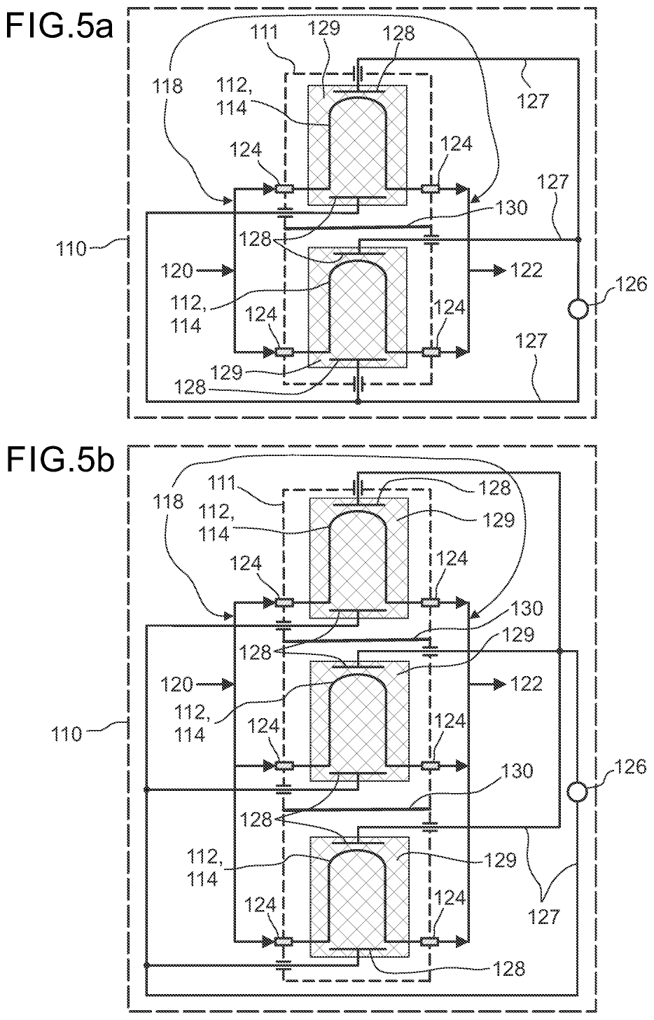

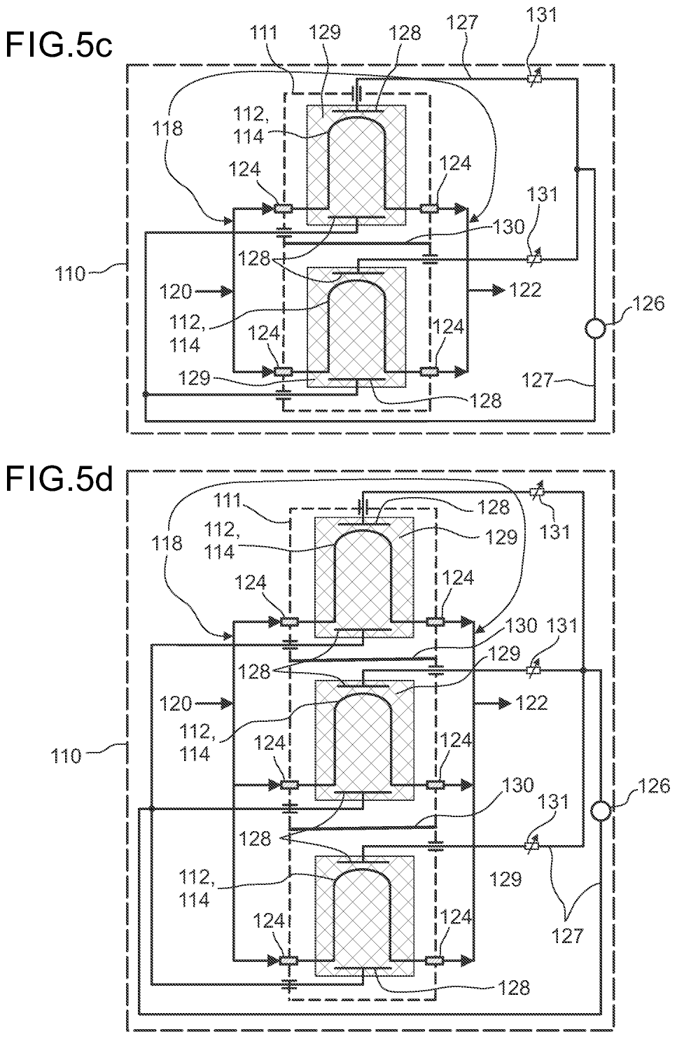

The power sources and/or voltage sources 126 may be configured with or without the possibility of controlling at least one electrical output variable. For example, the device 110 may have at least one controller 131. FIGS. 5c and 5d show examples of use of controllers 131. The aim of the controller may be to add an appropriate amount of voltage or power to the system, i.e. to control the current intensity. The pipelines 112 may require different amounts of power. For example, the amount of power may be dependent on the reaction. For example, in the case of a steamcracker, more energy may be needed at the start of the pipeline 112, and less at the end of the pipe. For example, coking in the pipe may lead to more electrical resistance over the period of utilization. The controller 131 may, for example, be an external controller, i.e. a controller 131 disposed outside the reaction space 111. The power sources and/or voltage sources 126 may be electrically controllable independently of one another. The power sources and/or voltage sources 126 may be of identical or different configuration. For example, the device 110 may be set up such that current and/or voltage are adjustable for different zones of the device 110. The device 110 may have a plurality of pipelines 112, where the pipelines 112 belong to different temperature regions or zones. The pipeline 112 itself may likewise have temperature zones. Using a plurality of power sources and/or voltage sources 126 allows the voltage in particular to be varied for different zones. For instance, it is possible to achieve not too high a current, which would result in excessively hot pipelines, and not too low a current, which would result in less product or more by-products.

The device 110 may have a plurality of single-phase or multiphase AC power sources or AC voltage sources. As shown in FIGS. 1b and 1c, the pipelines 112 may each be assigned a current-conducting medium 129 with an AC power source and/or AC voltage source connected to the current-conducting medium 129, especially electrically via at least one electrical connection. Also conceivable are embodiments in which at least two pipelines 112 share a current-conducting medium 129 and an AC power source and/or AC voltage source. For connection of the AC power source or AC voltage source and the current-conducting media 129, the electrically heatable reactor may have 2 to N inputs and outputs 127 where N is a natural number not less than three. The respective AC power source and/or AC voltage source may be set up to generate an electrical current in the respective current-conducting medium 129 for the purpose of generation of Joule heating.

The AC power sources and/or AC voltage sources may either be controlled or uncontrolled. The AC power sources and/or AC voltage sources may be configured with or without the possibility of controlling at least one electrical output variable. The output variable may be a current value and/or a voltage value and/or a current signal and/or a voltage signal. The device 110 may have 2 to M different AC power sources and/or AC voltage sources where M is a natural number not less than three. The AC power sources and/or AC voltage sources may be independently electrically controllable. For example, a different current may be generated in the respective current-conducting medium 129, and different temperatures reached in the pipelines 112.

The device 110 may comprise a plurality of DC power sources and/or DC voltage sources. As shown in FIGS. 1b and 1c, each pipeline 112 may be assigned a current-conducting medium 129 and a DC power source and/or DC voltage source connected to the current-conducting medium 129, especially electrically via at least one electrical connection. For connection of the DC power sources and/or DC voltage sources and the current-conducting medium, the device 110 may have 2 to N positive terminals and/or conductors and 2 to N negative terminals and/or conductors, where N is a natural number not less than three. The respective DC power source and/or DC voltage source may be set up to generate an electrical current in the respective current-conducting medium 129.

The current generated in the current-conducting medium 129 can heat the respective pipeline 112 by Joule heating that arises on passage of the electrical current through the current-conducting medium, in order to heat the feedstock. Warming of the pipeline 112 may be and/or comprise an operation that leads to a change in a temperature of the pipeline 112, especially a rise in the temperature of the pipeline 112. The temperature of the pipeline 112 may remain constant, for example when the reaction that takes place in the pipeline 112 absorbs as much heat as it receives.

The device 110 may be set up to heat the feedstock to a temperature in the range from 200° C. to 1700° C., preferably 300° C. to 1400° C., more preferably 400° C. to 875° C. The pipeline 112 may be set up to at least partly absorb the Joule heating generated by the current-conducting medium 129 and to at least partly release it to the feedstock. At least one endothermic reaction may take place in the pipeline 112. The endothermic reaction may comprise heating and/or preheating of the feedstock.

The device 110 may be part of a plant. For example, the plant may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

The current-conducting medium 129 may be disposed in any vessel 140, for example a pipe or a cylinder. The current-conducting medium 129 may be electrically heated directly or indirectly by heating of the vessel 140.

The current-conducting medium 129 and the pipeline 112 may be arranged relative to one another such that the current-conducting medium 129 at least partly surrounds the pipeline and/or that the pipeline at least partly surrounds the current-conducting medium. FIGS. 1a to 1c show embodiments in which the current-conducting medium 129 fully surrounds the pipelines 112. FIGS. 1a to 1c show embodiments in which the pipelines 112 are arranged as inner cylinder in a hollow cylinder and are surrounded by the current-conducting medium 129, for example a granular material. In FIGS. 1b and 1c, the device 110 has two separate vessels 140 for the respective pipelines 112.

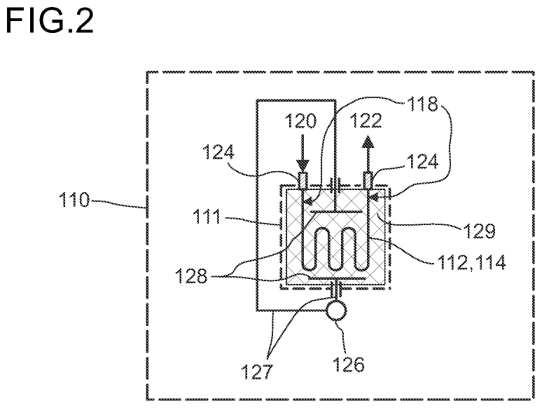

FIG. 2 shows a further embodiment of the inventive device 110. With regard to the configuration of the device, reference is made to the description of FIG. 1a with the characteristics that follow. In this embodiment, the device 110 has a pipeline 112 and/or pipeline segments 114 with three legs or turns that are fluidically connected. However, more than three legs are also possible. The device has the inlet 120 and the outlet 122. The feedstock can flow through the pipeline 112 and/or the pipeline segments 114 in series from the inlet 120 to the outlet 122. For galvanic isolation, the device 110 may have the insulators 124, for example two insulators 124, as shown in FIG. 2. In this embodiment, the device 110 has one power source and/or voltage source 126. For connection of the power source and/or voltage source 126 and the current-conducting medium 129, the device 110 may have electrical inputs and outputs 127.

FIGS. 3a1 to 3b2 show embodiments with parallel-connected pipelines 112 and/or pipeline segments 114. FIG. 3a1 shows an embodiment with two parallel pipelines 112 and/or pipeline segments 114 that are surrounded by a common current-conducting medium 129. In FIG. 3a1, the device 110 has three parallel pipelines 112 and/or pipeline segments 114 that are surrounded by a common current-conducting medium 129. Other numbers of parallel pipelines 112 and/or pipeline segments 114 are also conceivable. In FIGS. 3a1 and 3a2, the device 110 has an inlet 120 and an outlet 122. The pipelines 112 and/or pipeline segments 114 may be connected to one another in such a way that the feedstock can flow through at least two pipelines 112 and/or pipeline segments 114 in parallel. The pipelines 112 and/or pipeline segments 114 connected in parallel may have mutually different geometries and/or surfaces and/or materials. For example, the pipelines 112 and/or pipeline segments 114 connected in parallel may have different numbers of legs or turns.

FIG. 3b1 shows two parallel pipelines 112 and/or pipeline segments 114, each of which are surrounded by a current-conducting medium 129, with the respective current-conducting media 129 disposed in separate vessels 140. The current-conducting media 129 may be identical or different. The current-conducting media 129 may be chosen depending on a temperature requirement. In FIG. 3b1, the device 110 has for an inlet 120, where the feedstock is subsequently divided into two pipe strands and passes through the pipelines 112 and/or pipeline segments 114 in parallel. After passing through the parallel pipelines 112 and/or pipeline segments 114, the feed may be combined again and leave the reactive space 111 through the outlet 122. FIG. 3b2 shows a corresponding embodiment with three parallel pipelines 112 and/or pipeline segments 114. The power sources and/or voltage sources in FIGS. 3a1 to 3b2 may be configured with the possibility of control by controller 131 of the without possible control. FIG. 3 show embodiments without controller 131. Each pipeline 112 in FIG. 3 is assigned a dedicated power source or voltage source 126 and a reactive space or heater 111, also referred to as reaction box. The reactive spaces or heaters 111 may be insulated from one another by galvanic walls 130. FIG. 5 show embodiments in which a power source or voltage source 126 is used for multiple pipelines 112. The common power source or voltage source 126 may be used with one or more controllers for multiple pipelines 112.

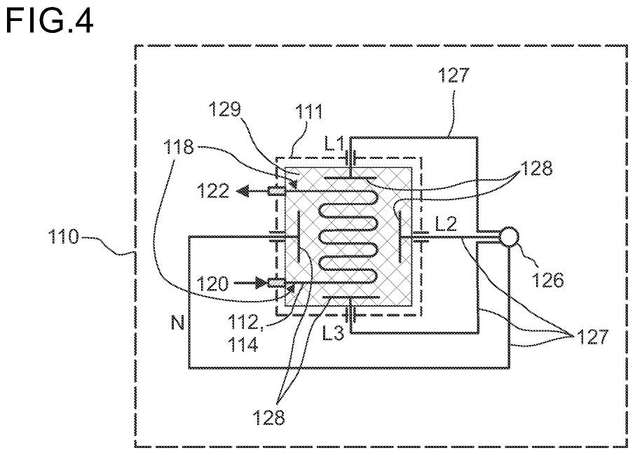

FIG. 4 shows a further embodiment of the inventive device 110. With regard to the configuration of the device, reference is made to the description relating to FIG. 2 with the characteristics that follow. In this embodiment, the device 110 has a pipeline 112 and/or pipeline segments 114 with a plurality of legs or turns that are fluidically connected. The device 110 in this embodiment further comprises a three-phase AC power source or AC voltage source 126. The three outside conductors are labelled L1, L2 and L3, and the neutral conductor N. Also conceivable is a multiphase AC power source or AC voltage source with nx3 conductors.

The pipelines 112 may comprise symmetric and/or asymmetric pipes and/or combinations thereof. The geometry and/or surfaces and/or material of the pipeline 112 may be dependent on a feedstock to be transported. In a purely symmetrical configuration, the device 110 may comprise pipelines 112 of an identical pipe type. The device 110 may have any combination of pipe types, which may for example also be connected as desired in parallel or in series. The pipe type may be one category or pipeline 112 design characterized by particular features. The pipe type may be characterized at least by one feature selected from the group consisting of: a horizontal configuration of the pipeline 112; a vertical configuration of the pipeline; a length in the inlet (I1) and/or outlet (I2) and/or transition (I3); a diameter in the inlet (d1) and outlet (d2) and/or transition (d3); number n of passes; length per pass; diameter per pass; geometry; surface; and material. The device 110 may comprise a combination of at least two different pipe types which are connected in parallel and/or in series. For example, the device may comprise pipelines 112 of different lengths in the inlet (I1) and/or outlet (I2) and/or transition (I3). For example, the device 110 may comprise pipelines 112 with an asymmetry of the diameters in the inlet (d1) and/or outlet (d2) and/or transition (d3). For example, the device 110 may comprise pipelines 112 with a different number of passes. For example, the device 110 may comprise pipelines 112 with passes with different lengths per pass and/or different diameters per pass. In principle, any combination of any pipe type in parallel and/or in series is conceivable.

The device 110 may comprise a plurality of inlets 120 and/or outlets 122 and/or production streams. The pipelines 112 of different or identical pipe types may be arranged in parallel and/or in series with a plurality of inlets 120 and/or outlets 122. Pipelines 112 may take the form of various pipe types in the form of a construction kit and may be selected and combined as desired, dependent on an end use. Use of pipelines 112 of different pipe types can enable more accurate temperature control and/or adjustment of the reaction when the feed is fluctuating and/or a selective yield of the reaction and/or an optimized methodology. The pipelines 112 may comprise identical or different geometries and/or surfaces and/or materials.

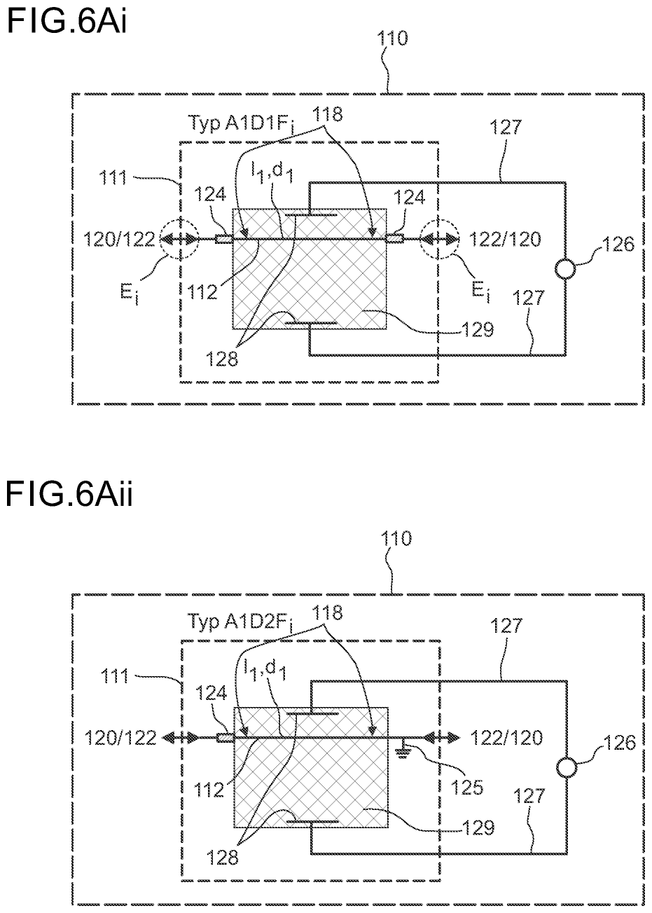

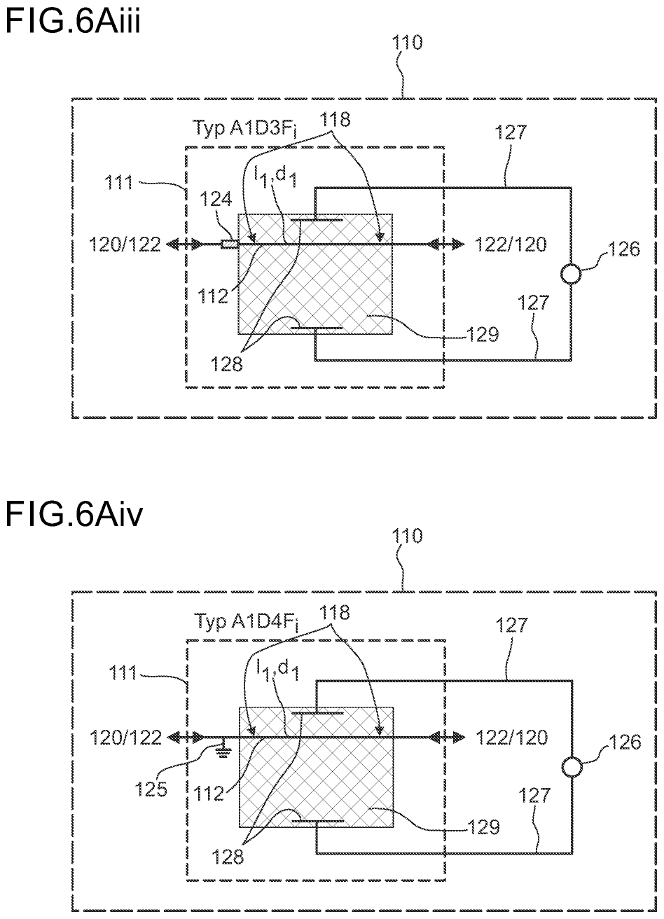

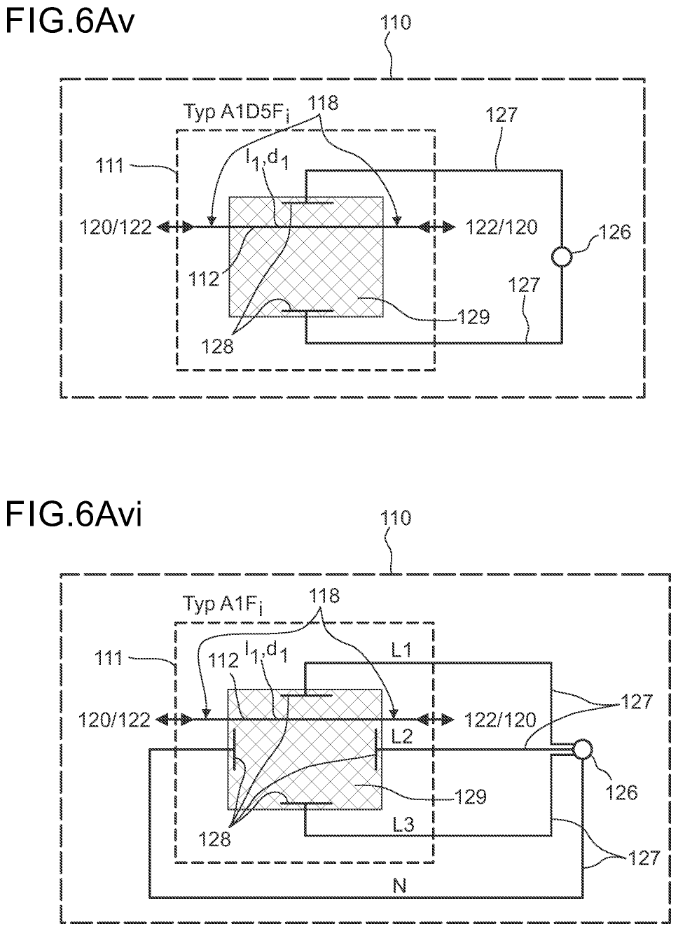

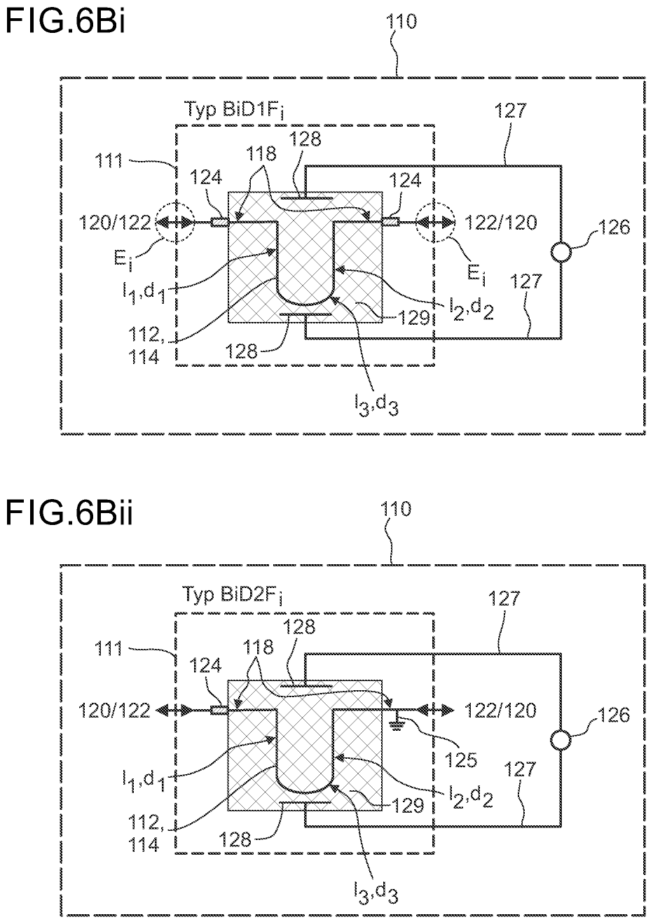

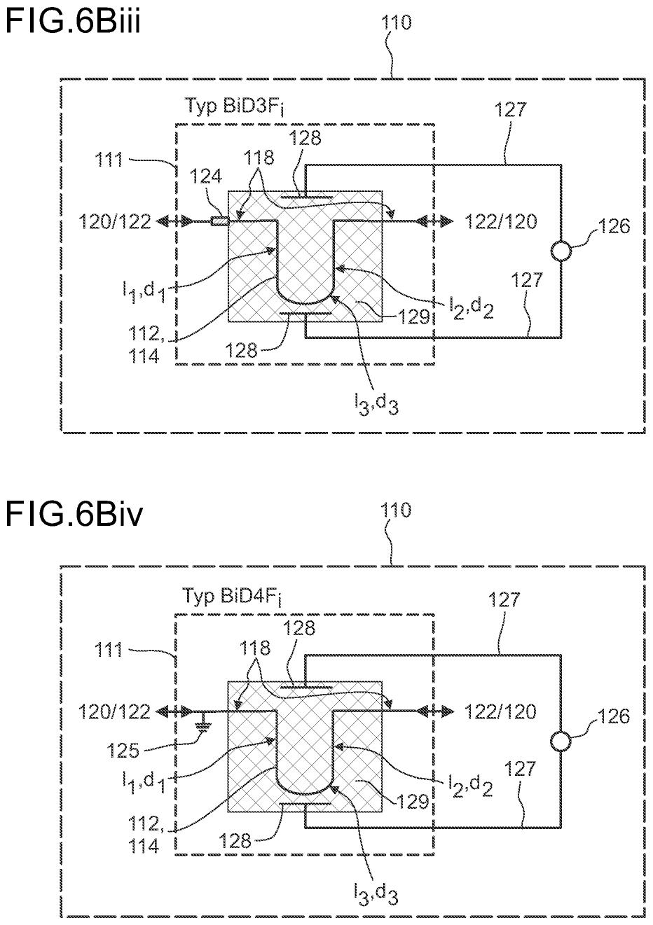

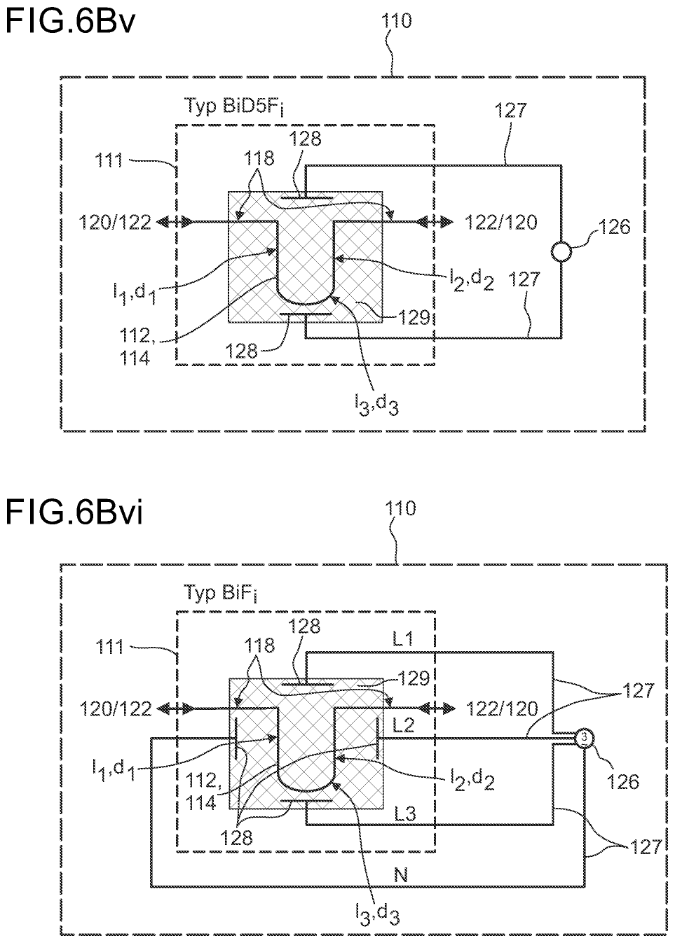

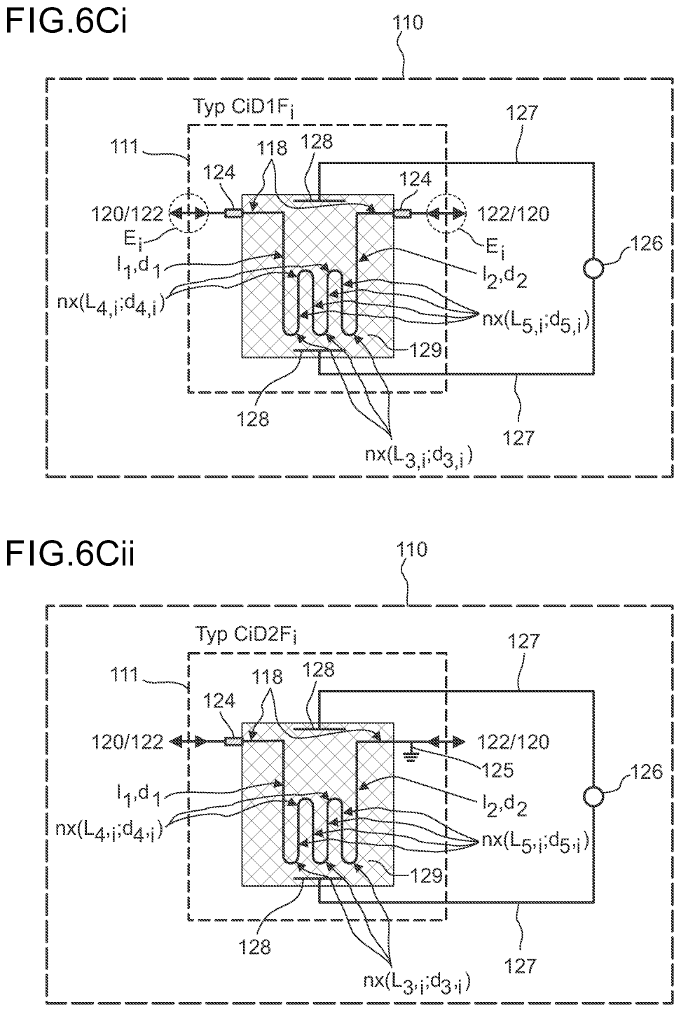

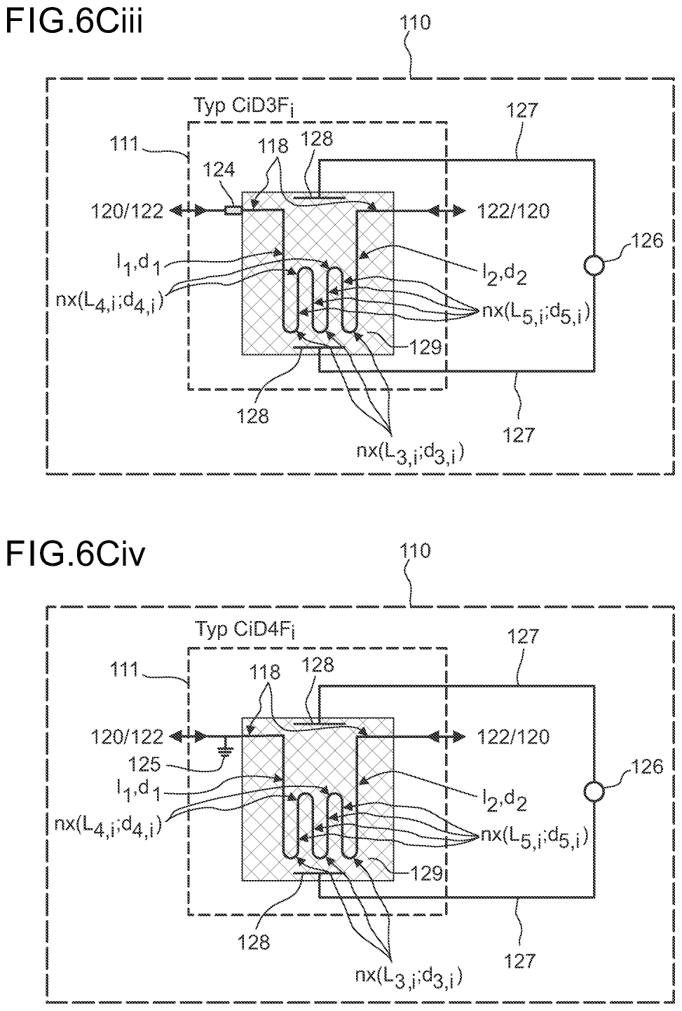

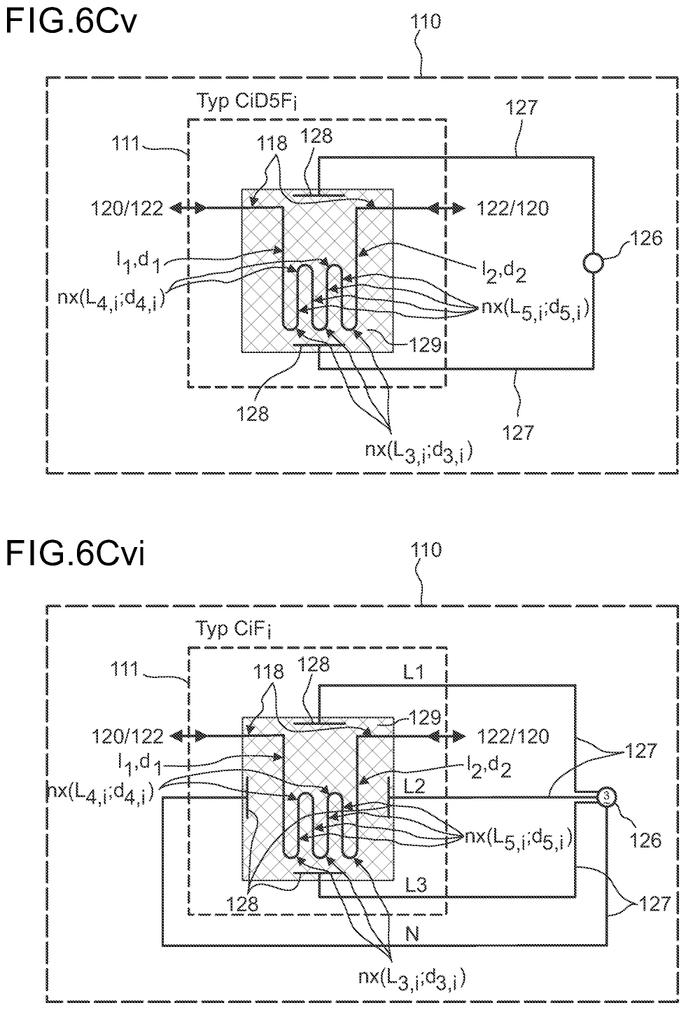

FIGS. 6Ai to 6Civ show possible embodiments by way of example of pipe types in a schematic diagram. FIGS. 6Ai to 6Civ each specify the pipe type. This can be divided into the following categories, with all conceivable combinations of categories being possible:
Category A indicates a course of the pipeline 112 and/or a pipeline segment 114, where A1 denotes a pipe type with a horizontal course and A2 a pipe type with a vertical course, i.e. a course perpendicular to the horizontal course.
Category B specifies a ratio of lengths in the inlet (I1) and/or outlet (I2) and/or diameter in the inlet (d1) and/or outlet (d2) and/or transition (d3), with six different possible combinations provided in the construction kit 134.
Category C indicates ratios of lengths in the inlet (I1) and/or outlet (I2) and lengths of passes. All combinations are conceivable here, which are labelled Ci in the present case.
Category D indicates whether the at least one pipeline 112 and/or the at least one pipeline segment 114 is configured with or without galvanic isolation and/or grounding 125. The galvanic isolation may, for example, be configured using an insulator 124. D1 denotes a pipe type in which a galvanic isolation is provided at the inlet 120 of the pipeline 112 and/or the pipe segment 114, and a galvanic isolation at the outlet 122 of the pipeline 112 and/or the pipe segment 114. D2 denotes a pipe type in which a galvanic isolation is provided at the inlet 120 of the pipeline 112 and/or the pipe segment 114 and a grounding 125 is provided at the outlet 122 of the pipeline 112 and/or the pipe segment 114. D3 denotes a pipe type in which a galvanic isolation is provided only at the inlet 120 of the pipeline 112 and/or the pipe segment 114. D4 denotes a pipe type in which a grounding 125 is provided only at the inlet 120 of the pipeline 112 and/or the pipe segment 114. D5 denotes a pipe type in which the pipeline 112 and/or the pipe segment 114 is provided without grounding 125 at the inlet 120 and outlet 122 and/or without galvanic isolation at the inlet 120 and outlet 122.
Category E indicates a direction of flow of the feedstock. The feedstock can in principle flow in two directions of flow. A pipe type in which the feedstock flows in a first direction of flow is referred to as pipe type E1, and a pipe type in which the feedstock flows in a second direction of flow is referred to as pipe type E2. The first and second directions of flow can be opposite.
Category F includes the number of electrodes: F1 indicates that a number of electrodes is ≤2, for example in the case of a DC power source or an AC power source. F2 indicates that a number of electrodes is >2, for example for a three-phase power source.

FIG. 6Ai shows a pipeline 112 and/or a pipeline segment 114 of pipe type A1D1Fi. The pipeline 112 and/or the pipeline segment 114 has a horizontal course. In this embodiment, the device 110 has two insulators 124 disposed after the inlet 120 and before the outlet 122. With regard to the further elements of FIG. 6Ai, reference may be made to the description of FIG. 1a. FIG. 6Ai shows possible directions of flow Ei by way of example by a double-headed arrow at inlet 120 and outlet 122. In the further FIGS. 6, inlet 120 and outlet 122 are denoted collectively.

The working example in FIG. 6Aii shows a pipe type A1D2Fi and differs from FIG. 6Ai in that the device 110 has only one insulator 124, with provision of a grounding 125 instead of the second insulator. The working example in FIG. 6Aiii shows a pipe type A1D3Fi and differs from FIG. 6Aii in that no grounding 125 is provided. In FIG. 6Aiv, pipe type A1D4Fi, the device 110, by comparison with FIG. 6Aiii, has only a grounding 125 instead of the insulator. Embodiments without insulators 124 or groundings 125 are also possible, as shown in FIG. 6Av, pipe type A1D5Fi.

FIG. 6Bi, pipe type BiD1Fi shows lengths in the inlet (I1), outlet (I2) and transition (I3) and diameters in the inlet (d1), outlet (d2) and transition (d3). The device 110 may comprise pipelines 112 and/or pipeline segments 114 with different lengths in the inlet (I1) and/or outlet (I2) and/or transition (I3) and/or diameters in the inlet (d1) and/or outlet (d2) and/or transition (d3). With regard to the further elements of FIG. 6Bi, reference may be made to the description of FIGS. 1. The working example in FIG. 6Bii shows a pipe type BiD2Fi and differs from FIG. 6Bi in that the device 110 has only one insulator 124, with provision of a grounding 125 instead of the second insulator. The working example in FIG. 6Biii shows a pipe type BiD3Fi and differs from FIG. 6Bii in that no grounding 125 is provided. In FIG. 6Biv, pipe type BiD4Fi, the device 110, by comparison with FIG. 6Biii, has only a grounding 125 instead of the insulator. Embodiments without insulators 124 or groundings 125 are also possible, as shown in FIG. 6Bv, pipe type BiD5Fi.

FIG. 6Ci, pipe type CiD1Fi, shows a working example in which the device 110 has pipelines 112 and/or pipeline segments 114 with a plurality n of passes, for example three, as shown here. The passes may each have different lengths 13, 14, 15 and/or diameters d3, d4, d5. With regard to the further elements of FIG. 6Ci, reference may be made to the description of FIG. 2. The working example in FIG. 6Cii shows a pipe type CiD2Fi and differs from FIG. 6Ci in that the device 110 has only one insulator 124, with provision of a grounding 125 instead of the second insulator. The working example in FIG. 6Ciii shows a pipe type CiD3Fi and differs from FIG. 6Cii in that no grounding 125 is provided. In FIG. 6Civ, pipe type CiD4Fi, the device 110, by comparison with FIG. 6Ciii, has only a grounding 125 instead of the insulator. Embodiments without insulators 124 or groundings 125 are also possible, as shown in FIG. 6Cv, pipe type CiD5Fi. FIGS. 6Ci to 6Cvi show pipe types in which the alternating current is fed in via a connection of the electrical input or output 127 at the start or end of the pipeline 112 and/or the pipe segment 114. FIG. 6Cvi shows a pipe type CiFi in which the alternating current is fed in midway along the pipeline 112 and/or the pipe segment 114.

The device 110 may comprise a combination of at least two different pipe types which are connected in parallel and/or in series. For example, the device 110 may have pipelines 112 and/or pipeline segments 114 of different lengths in the inlet (I1) and/or outlet (I2) and/or transition (I3). For example, the device may comprise pipelines and/or pipeline segments with an asymmetry of the diameters in the inlet (d1) and/or outlet (d2) and/or transition (d3). For example, the device 110 may comprise pipelines 112 and/or pipeline segments 114 with a different number of passes. For example, the device 110 may comprise pipelines 112 and/or pipeline segments 114 with passes with different lengths per pass and/or different diameters per pass.

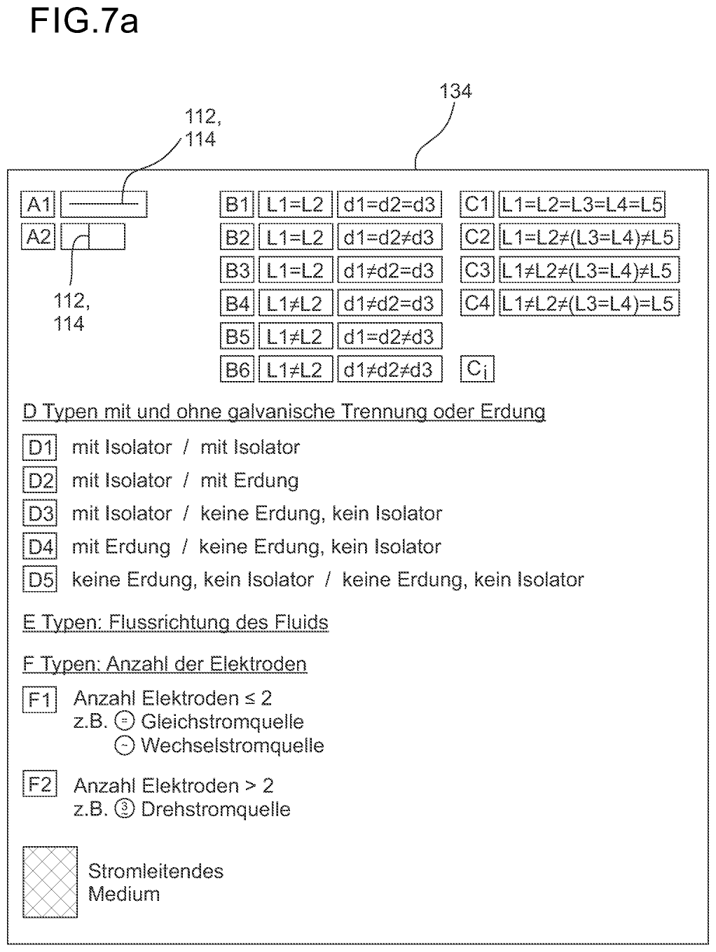

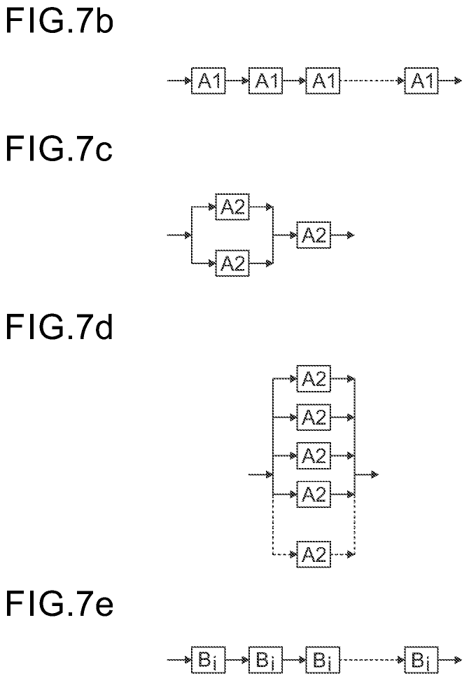

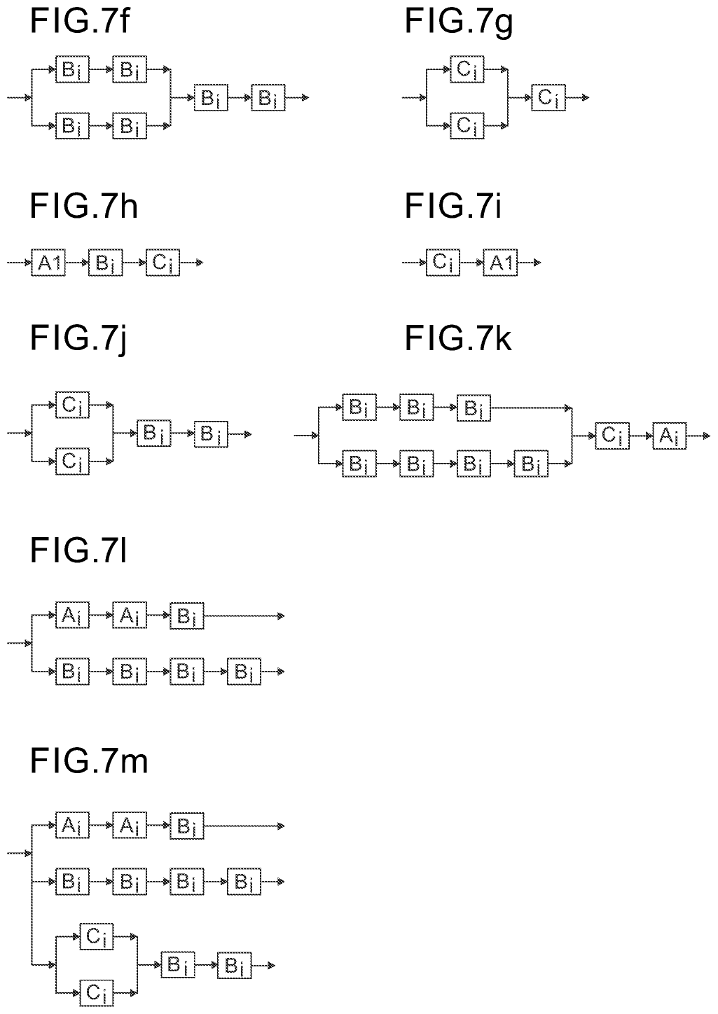

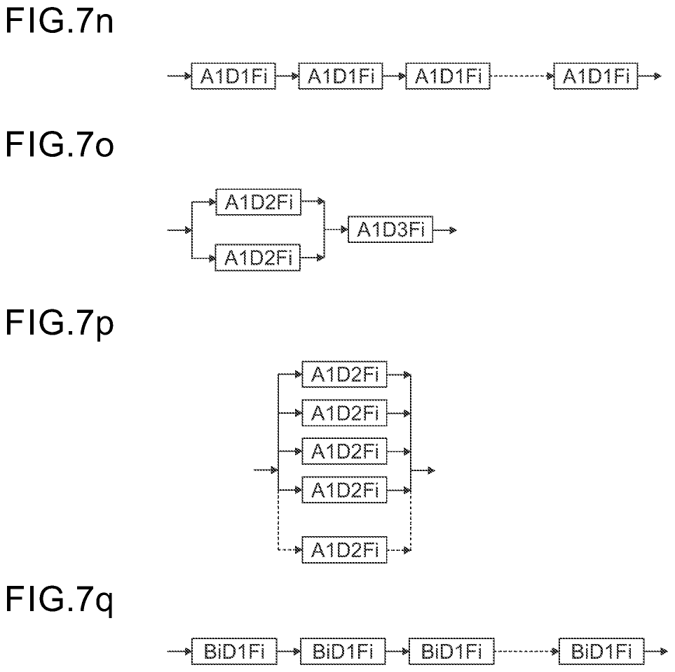

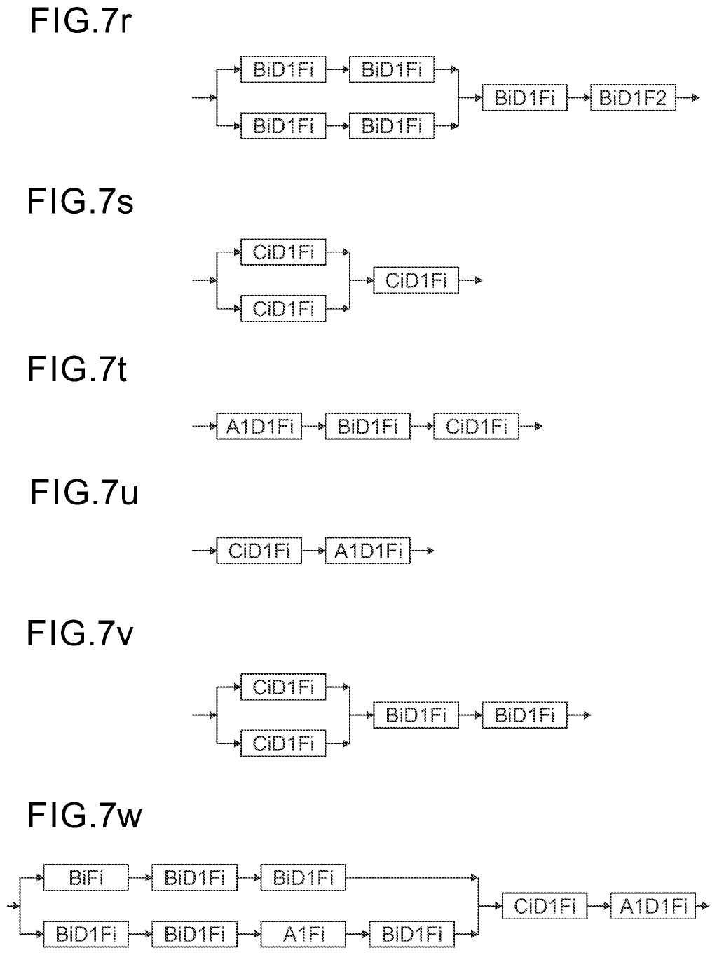

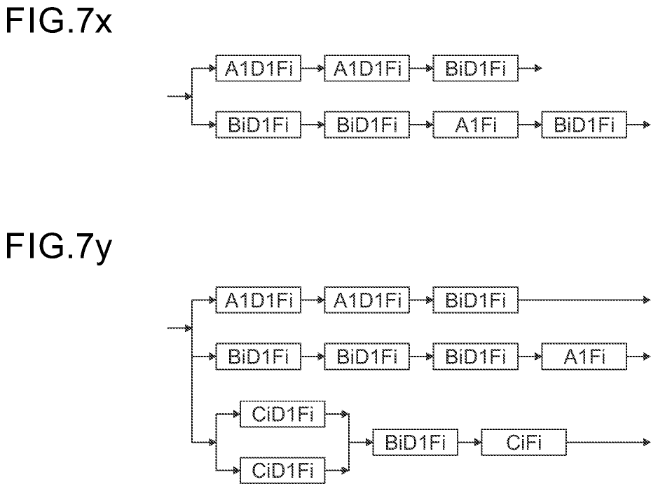

In principle, any combination of any pipe type in parallel and/or in series is conceivable. Pipelines 112 and/or pipeline segments 114 may take the form of various pipe types in the form of a construction kit 134 and may be selected and combined as desired, dependent on an end use. FIG. 7a shows an embodiment of a construction kit 134 with different pipe types.

FIGS. 7b to 7y show inventive working examples of combinations of pipelines 112 and/or pipeline segments 114 of the same and/or different pipe type. FIG. 7b shows a working example with three horizontal pipelines 112 and/or pipeline segments 114 of pipe type A1, arranged in succession. FIG. 7c shows two vertical pipes of pipe type A2 connected in parallel and one downstream pipeline 112 and/or one downstream pipeline segment 114, likewise of pipe type A2. FIG. 7d shows a plurality of pipelines 112 and/or pipeline segments 114 of pipe type A2, which are all connected in parallel. FIG. 7e shows an embodiment in which a plurality of pipe types of category B are arranged in succession. The pipelines 112 and/or pipeline segments 114 here may be identical or different pipe types of category B, identified by Bi. FIG. 7f shows an embodiment with six pipelines 112 and/or pipeline segments 114 of category B, with arrangement in two parallel strands of two pipelines 112 and/or pipeline segments 114 and with two further pipelines 112 and/or pipeline segments 114 connected downstream. FIG. 7g shows an embodiment with pipelines 112 and/or pipeline segments 114 of category C, with parallel connection of two pipelines 112 and/or pipeline segments 114 and with one pipeline 112 and/or one pipeline segment 114 connected downstream. Also possible are mixed forms of categories A, B and C, as shown in FIGS. 7h to 7m. The device 110 may have a plurality of feed inlets and/or feed outlets and/or production streams. The pipelines 112 and/or pipeline segments 114 of different or identical pipe type may be arranged in parallel and/or in series with a plurality of feed inlets and/or feed outlets, as shown for example in FIGS. 7k and 7m.

FIGS. 7n to 7p show illustrative combinations of pipelines 112 and/or of pipeline segments 114 of categories A, D and Fi. FIGS. 7q and 7r show illustrative combinations of pipelines 112 and/or of pipeline segments 114 of categories B, D and Fi. FIG. 7s shows an illustrative combination of pipelines 112 and/or of pipeline segments 114 of categories C, D and Fi. FIG. 7t shows an illustrative combination of pipelines 112 and/or of pipeline segments 114 of categories A, D and Fi. FIG. 7u shows an illustrative combination of pipelines 112 and/or of pipeline segments 114 of categories A, C, D and Fi. FIG. 7v shows an illustrative combination of pipelines 112 and/or of pipeline segments 114 of categories B, C, D and Fi. FIGS. 7w and 7y show illustrative combinations of pipelines 112 and/or of pipeline segments 114 of categories A, B, C, D and Fi. FIG. 7x shows an illustrative combination of pipelines 112 and/or of pipeline segments 114 of categories A, B, D and Fi. The device 110 may have a plurality of feed inlets and/or feed outlets and/or production streams. The pipelines 112 and/or pipeline segments 114 of different or identical pipe types of categories A, B, C, D and E may be arranged in parallel and/or in series with a plurality of feed inlets and/or feed outlets. Examples of a plurality of feed inlets and/or feed outlets and/or production streams are shown in FIGS. 7o, 7p, 7r, 7s, 7v to 7y.

Use of pipelines 112 and/or pipeline segments 114 of different pipe types can enable more accurate temperature control and/or adjustment of the reaction when there is a fluctuating feed and/or a selective yield of the reaction and/or optimized chemical engineering.

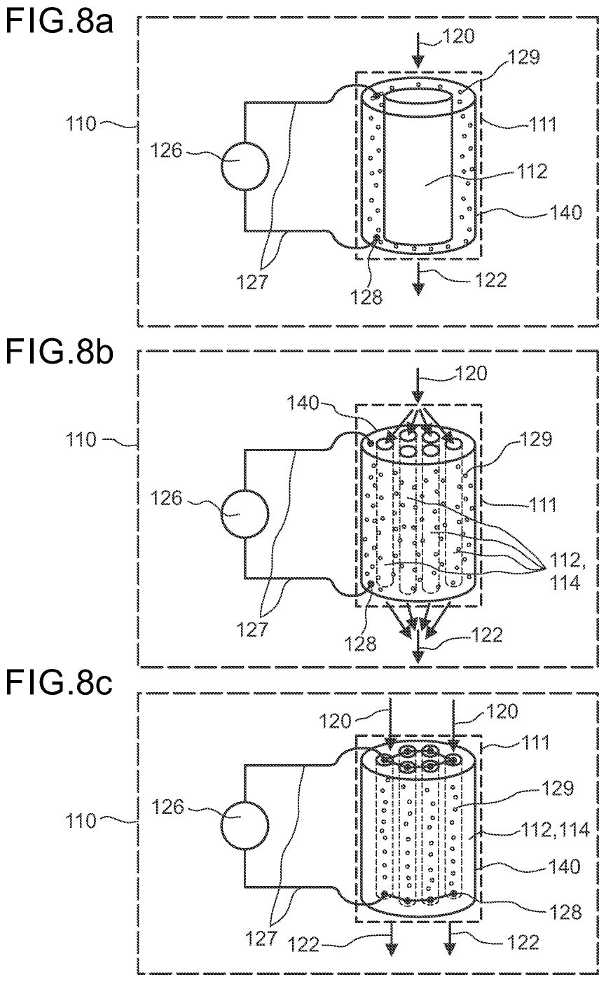

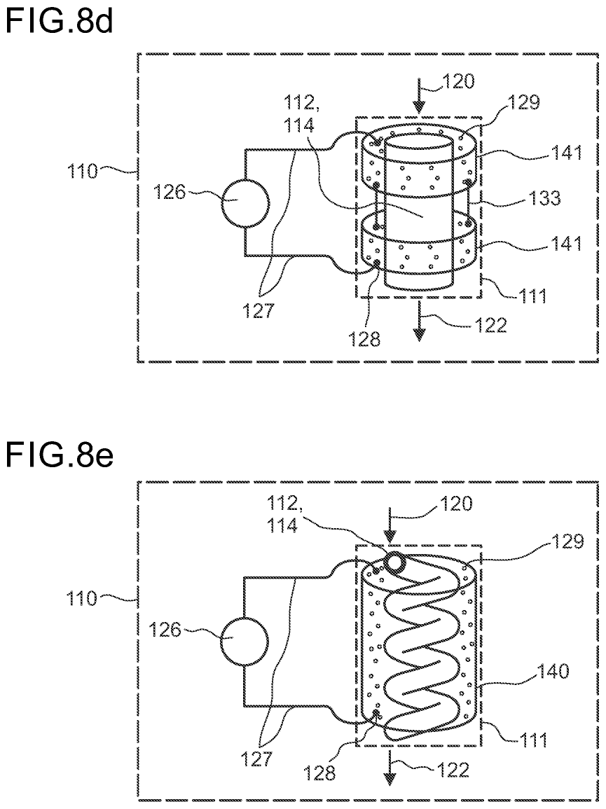

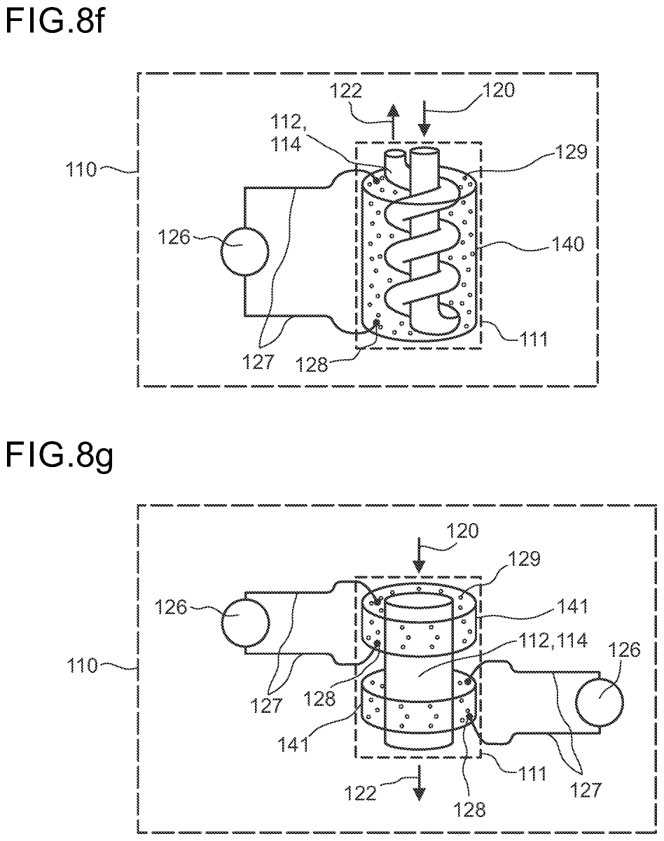

FIGS. 8a to 8e show schematic diagrams of further working examples of the device of the invention. FIG. 8a shows a vessel 140 in the form of a hollow cylinder that comprises the current-conducting medium 129 and surrounds a pipeline 112 in the form of an inner cylinder. FIG. 8b shows an embodiment in which the device 110 has multiple pipelines 112 comprising feedstock, also referred to as reaction fluid, with a vessel 140 in the form of a cylinder filled with the current-conducting medium 129 arranged around the pipelines 112. FIG. 8c shows an embodiment in which the device 110 has multiple tubes comprising current-conducting medium 129, with a pipeline 112 comprising the feedstock arranged around the tubes. As shown in FIG. 8d, multiple cylinders comprising current-conducting medium 129 may be arranged in the form of a ring around the pipeline 112 comprising the feedstock. As shown in FIG. 8e, the pipeline 112 may be in spiral form, and a cylinder comprising the current-conducting medium 129 may be arranged around the pipeline 112. FIG. 8f shows an asymmetric pipeline 112 in which inlet 120 and outlet 122 are arranged on the same side of the pipeline 112. FIG. 8g shows a further ring-shaped embodiment, wherein each ring 141 is assigned a dedicated power source or voltage source 126, in order that the rings 141 in this embodiment are heated separately. For example, one of the rings 141 may be used for preheating and the other for a reaction, or both rings 141 may be used for preheating operations or for reactions.

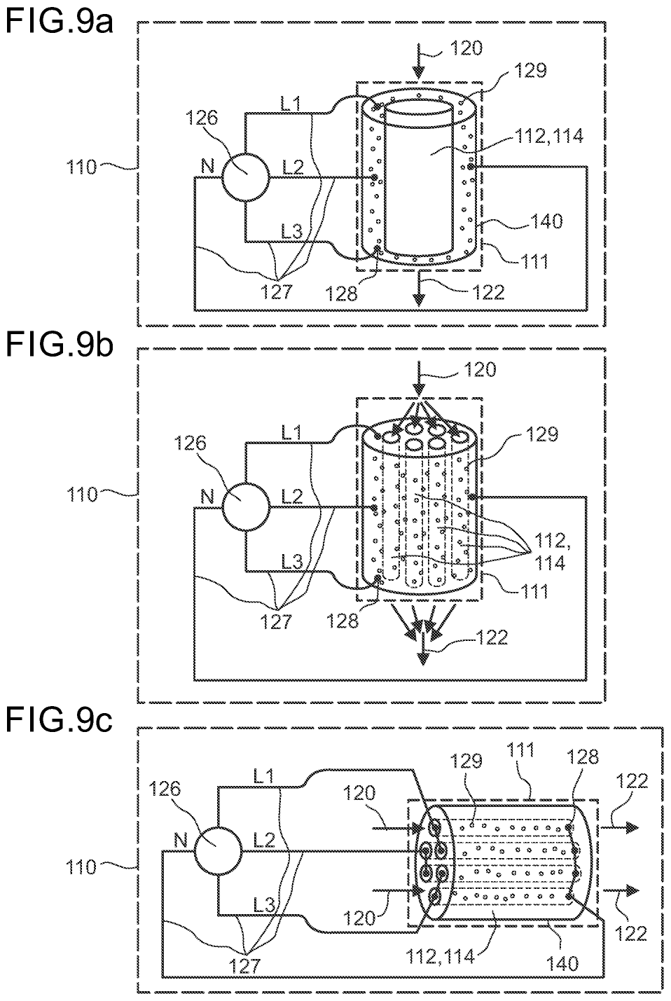

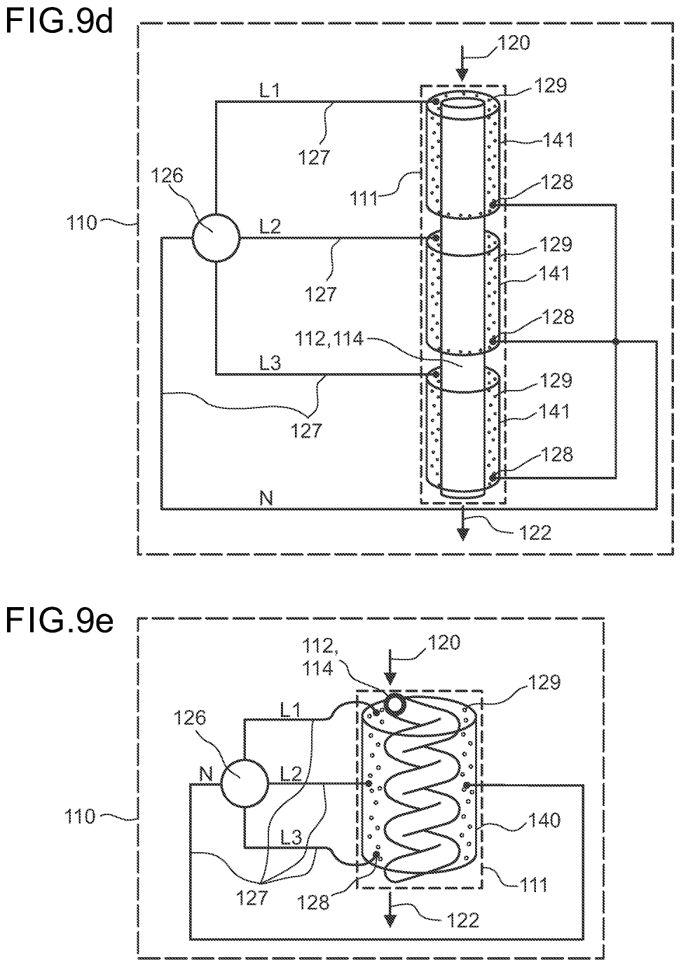

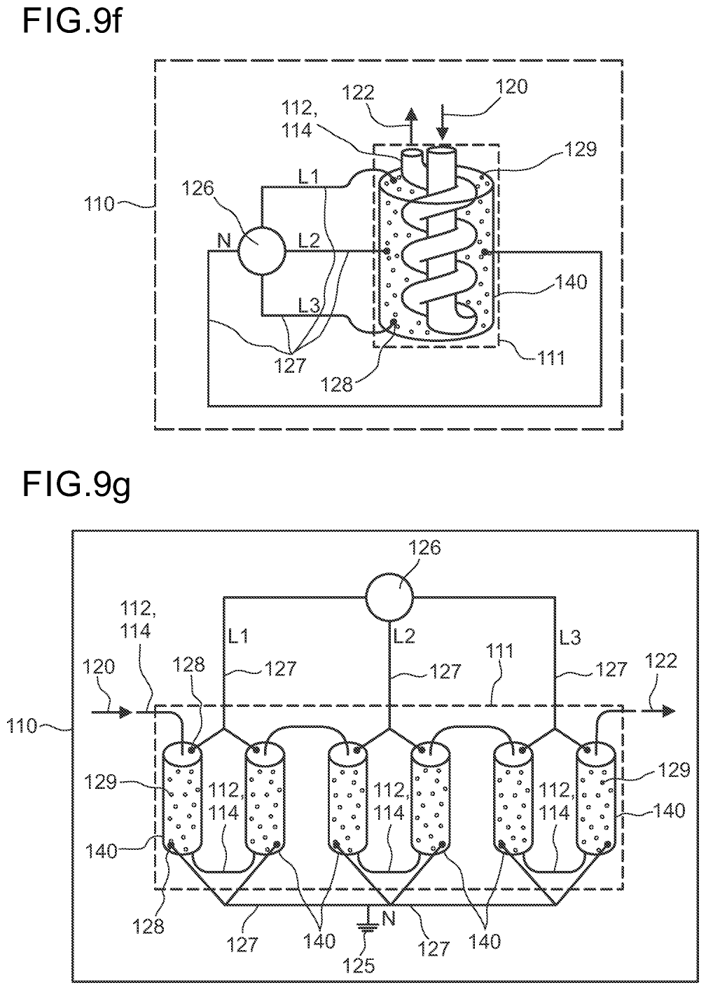

FIGS. 9a to 9g show further schematic diagrams of further working examples of the device 110 of the invention. FIGS. 9a to f show embodiments in which the current-conducting medium 129 is heated by means of 3-phase alternating current or 3-phase AC voltage. The three outside conductors are labelled L1, L2 and L3, and the neutral conductor N. In FIG. 9a, a hollow cylinder for the current-conducting medium 129 with an inner cylinder for the feedstock is provided. FIG. 9b shows an embodiment with multiple pipelines 112 that are surrounded by a cylinder filled with current-conducting medium 129. In FIG. 9c, multiple vessels 140 in the form of cylinders comprising current-conducting medium 129 are provided, surrounded by a pipeline 112 comprising feedstock. FIG. 9d shows an embodiment with three rings 141 comprising current-conducting medium 129 which are arranged around a pipeline 112 comprising feedstock. FIG. 9e shows a spiral-shaped pipeline 112 comprising feedstock, surrounded by a cylinder comprising current-conducting medium 129. Also conceivable are embodiments in which a spiral-shaped tube comprising current-conducting medium 129 is provided, surrounded by a pipeline 112. Also possible are embodiments with a concatenation of pipelines for electrical engineering purposes, for example multiple spiral-shaped elements in the cylinder. FIG. 9f shows an embodiment with asymmetry of the pipeline 112. Asymmetry may generally be possible, for example, inlet 120 and outlet 122 may be on the same side of the pipeline. FIG. 9g shows an embodiment in which the current-conducting medium 129 are arranged in hollow cylinders around various regions of a pipeline 112 and are arranged for electrical engineering purposes.

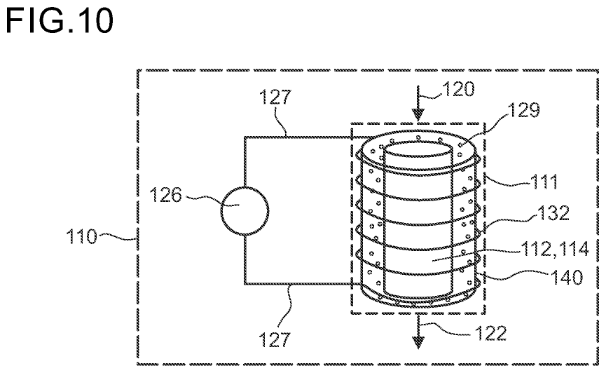

FIG. 10 shows an embodiment with inductive heating of the pipeline 112. The device 110 may have at least one coil 132. The power source or voltage source 126 may be connected to the coil 132, which is set up to supply the coil 132 with a voltage or a current. The current-conducting medium 129 and the coil 132 may be arranged such that the electromagnetic field of the coil 132 induces an electrical current in the current-conducting medium, which heats the current-conducting medium by Joule heating that arises on passage of the electrical current through the current-conducting medium 129, in order to heat the feedstock. The coil geometry may be of any configuration. For example, the coil 132 may be of vertical, horizontal, cylindrical or else different configuration. Multiple inductive heaters may be provided in the reactive space or heater 111, which may, for example, be in parallel, series or different arrangement.

### LIST OF REFERENCE NUMERALS

110 Device
111 Reactive space or heater
112 Pipeline
114 Pipeline segment
118 Pipe system
120 Inlet
122 Outlet
124 Insulator
125 Grounding
126 Voltage/power source
127 Electrical input and output
128 Electrodes
129 Current-conducting medium
130 Galvanically insulating wall
131 Controller
132 Coil
133 Electrode bridge
134 Construction kit
140 Vessel, e.g. cylinder
141 Ring

1.-14. (canceled)

15. A device comprising at least one pipeline for receiving at least one feedstock, said device having at least one current-conducting medium, said current-conducting medium having a specific resistivity ρ of 0.1 Ωmm²/m≤ρ≤1000 Ωmm²/m, and said device having at least one power source or voltage source set up to generate an electrical current in the current-conducting medium which heats the pipeline by Joule heating that arises on passage of the electrical current through the current-conducting medium.

16. The device according to claim 15, wherein the device is set up to heat the feedstock to a temperature in the range from 200° C. to 1700° C.

17. The device according to claim 15, wherein the current-conducting medium and the pipeline are arranged relative to one another such that the current-conducting medium at least partly surrounds the pipeline and/or that the pipeline at least partly surrounds the current-conducting medium.

18. The device according to claim 15, wherein the current-conducting medium is in a solid, liquid and/or gaseous state of matter selected from the group consisting of solid, liquid, gaseous and mixtures.

19. The device according to claim 15, wherein the current-conducting medium is a current-conducting granular material or a current-conducting fluid.

20. The device according to claim 15, wherein the current-conducting medium includes at least one material selected from the group consisting of: carbon, carbides, silicides, electrically conductive oils, salt melts, inorganic salts and solid/liquid mixtures.

21. The device according to claim 15, wherein the current-conducting medium has a specific resistivity ρ of 10 Ωmm²/m≤ρ≤1000 Ωmm²/m.

22. The device according to claim 15, wherein the power source and/or voltage source comprises a single-phase or multiphase AC power source and/or a single-phase or multiphase AC voltage source, or a DC power source and/or DC voltage source.

23. The device according to claim 15, wherein the device has a plurality of pipelines, said device having 1 pipelines where 1 is a natural number not less than two, and said pipelines having symmetric or asymmetric pipes and/or a combination thereof.

24. The device according to claim 23, wherein the pipelines are of different configuration with regard to diameter, and/or length, and/or geometry.

25. The device according to claim 23, wherein two or more or all of the pipelines are in series and/or parallel configuration.

26. The device according to claim 15, wherein the feedstock is a hydrocarbon to be subjected to thermal cleavage and/or a mixture.

27. A plant comprising at least one device according to claim 15, wherein the plant is selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation.

28. A method of heating at least one feedstock using a device according to claim 15 relating to a device, said method comprising the following steps:
providing at least one pipeline for receiving the feedstock and receiving the feedstock in the pipeline;
providing at least one power source and/or at least one voltage source;
generating an electrical current in a current-conducting medium in the device, which heats the pipeline by Joule heating that arises on passage of the electrical current through the current-conducting medium, in order to heat the feedstock, said current-conducting medium having a specific resistivity ρ of 0.1 Ωmm²/m≤ρ≤1000 Ωmm²/m.
